(19) United States
(12) Patent Application Publication
(10) Pub. No.: US 2026/0095539 A1
(43) Pub. Date: Apr. 2, 2026

(54) CORRECTION METHOD AND NON-TRANSITORY COMPUTER-READABLE STORAGE MEDIUM STORING PROGRAM

(71) Applicant: SEIKO EPSON CORPORATION, Tokyo (JP)

(72) Inventors: Shiki FURUI, Matsumoto-shi (JP); Momoko IMAI, Matsumoto-shi (JP)

(73) Assignee: SEIKO EPSON CORPORATION, Tokyo (JP)

(21) Appl. No.: 19/341,852

(22) Filed: Sep. 26, 2025

(30) Foreign Application Priority Data
Sep. 27, 2024 (JP) 2024-169353

(51) Int. Cl. H04N 1/60; G06T 7/90; G06V 10/60; H04N 5/74

(52) U.S. Cl. CPC H04N 1/60; G06T 7/90; G06V 10/60; H04N 5/74; G06T 2207/10024

(57) ABSTRACT

An image correction method includes: acquiring one piece of correction information among a plurality of pieces of correction information for correcting a third image based on first information indicating whether to give priority to a contrast ratio of the third image or color unevenness of the third image, the third image including a first region in which a first image projected on the projection surface by a first projecting apparatus and a second image projected n the projection surface by a second projecting apparatus overlap each other and a second region in which the first image and the second image do not overlap each other; and performing correction of reducing a difference in brightness of black on the projection surface between the first region and the second region and reducing the color unevenness of the third image based on the first correction information.

The present application is based on, and claims priority from JP Application Serial Number 2024-169353, filed Sep. 27, 2024, the disclosure of which is hereby incorporated by reference herein in its entirety.

### BACKGROUND

### 1. Technical Field

The present disclosure relates to an image correction method and a non-transitory computer-readable storage medium storing a program.

### 2. Related Art

JP-A-2013-254028 discloses a projector that projects an image and includes an offset unit, a color unevenness corrector, a black adjuster, and an inverse corrector. The offset unit is a luminance adjuster having a function of offsetting a signal level of the entire video signal (entire image). The color unevenness corrector is a luminance adjuster that adjusts luminance unevenness of a projection image to make luminance of the projection image uniform in a plane. The black adjuster adjusts luminance of a non-overlapping region so as to match black luminance of an overlapping region where an image projected by a projector and an image projected by another projector overlap each other on a projection surface with black luminance of the non-overlapping region where projection images do not overlap each other. The reverse corrector subtracts an offset amount corresponding to a value set by a user from an offset amount that has already been increased when the offset unit is set to offset signal levels in a direction of adding the signal level or when the color unevenness corrector is set to offset signal levels in the overlapping region in a direction of adding the signal levels.

JP-A-2013-254028 is an example of the related art.

In the method disclosed in JP-A-2013-254028, color unevenness correction is performed with a predetermined value, and thus contrast may be sacrificed. However, preferable quality of an image to be displayed varies depending on a use environment of a projecting apparatus that displays an image and a type of projection content.

### SUMMARY

An image correction method according to an aspect of the present disclosure includes: acquiring one piece of correction information among a plurality of pieces of correction information for correcting a third image based on first information indicating whether to give priority to a contrast ratio of the third image or color unevenness of the third image, the third image including a first region in which a first image projected on a projection surface by a first projecting apparatus and a second image projected on the projection surface by a second projecting apparatus overlap each other and a second region in which the first image and the second image do not overlap each other; and performing correction of reducing a difference in brightness of black on the projection surface between the first region and the second region and reducing the color unevenness of the third image based on the one piece of correction information.

A non-transitory computer-readable storage medium storing a program according to an aspect of the present disclosure causes a processor to execute: acquiring first information for selecting one piece of correction information among a plurality of pieces of correction information for correcting a third image based on first information indicating whether to give priority to a contrast ratio of the third image or color unevenness of the third image, the third image including a first region in which a first image projected on a projection surface by a first projecting apparatus and a second image projected on the projection surface by a second projecting apparatus overlap each other and a second region in which the first image and the second image do not overlap each other; and performing correction of reducing a difference in brightness of black on the projection surface between the first region and the second region and reducing the color unevenness of the third image based on the one piece of correction information.

### BRIEF DESCRIPTION OF THE DRAWINGS

FIG. 1 is a diagram illustrating an overall configuration of a projection system 1.

FIG. 2 is a block diagram illustrating a projecting apparatus 10A.

FIG. 3 is a functional block diagram illustrating a corrector 136.

FIG. 4 is a flowchart illustrating an operation example of the projecting apparatus 10A according to a first embodiment.

FIG. 5 is a diagram illustrating an example of grid points LP.

FIG. 6 is a diagram illustrating an example of the grid points LP.

FIG. 7 is a diagram illustrating an example of the grid points LP.

FIG. 8 is a diagram illustrating a projection image PI_A corrected with priority given to a contrast ratio, and pre-correction luminance BA_a and post-correction luminance BA_b in the projection image PI_A.

FIG. 9 is a diagram illustrating a projection image PI_A corrected with priority given to accuracy of color unevenness correction, and pre-correction luminance BA_a and post-correction luminance BA_b in the projection image PI_A.

FIG. 10 is a diagram illustrating a luminance gradient.

FIG. 11 is a diagram illustrating a luminance gradient.

FIG. 12 is a diagram illustrating a luminance gradient.

FIG. 13 is a diagram illustrating an example of luminance BA.

FIG. 14 is a diagram illustrating an example of color unevenness correction values UA.

FIG. 15 is a diagram illustrating a correction method of leaving a step DD.

FIG. 16 is a diagram illustrating an example of luminance BA_a, luminance BA_c, and luminance BA_b.

FIG. 17 is a diagram illustrating an example of a projection image PI_A after correction.

FIG. 18 is a flowchart illustrating sub-steps SS4[1] to SS4[5] of step S4.

FIG. 19 is a diagram illustrating an example of a correction region of a brightness correction circuit LC.

FIG. 20 is a diagram illustrating a processing procedure of the brightness correction circuit LC and a color unevenness correction circuit UC.

FIG. 21 is a diagram illustrating an example of how a color unevenness correction value S₀, a brightness correction value C₀, an ideal output value Aᵢ, and a color unevenness correction value S₁ are calculated in sub-step SS4[1].

FIG. 22 is a diagram illustrating an example of how the color unevenness correction value S₀, the brightness correction value C₀, the ideal output value Aᵢ, and the color unevenness correction value S₁ are calculated in sub-step SS4[2].

FIG. 23 is a diagram illustrating an example of how the color unevenness correction value S₀, the brightness correction value C₀, the ideal output value Aᵢ, and the color unevenness correction value S₁ are calculated in sub-step SS4[2].

FIG. 24 is a diagram illustrating processing contents in sub-step SS4[3].

FIG. 25 is a diagram illustrating an example of how the color unevenness correction value S₀, the brightness correction value C₀, the ideal output value Aᵢ, and the color unevenness correction value S₁ are calculated in sub-step SS4[3].

FIG. 26 is a diagram illustrating an example of how the color unevenness correction value S₀, the brightness correction value C₀, the ideal output value Aᵢ, and the color unevenness correction value S₁ are calculated in sub-step SS4[4].

FIG. 27 is a diagram illustrating an example of how the color unevenness correction value S₀, the brightness correction value C₀, the ideal output value Aᵢ, and the color unevenness correction value S₁ are calculated in sub-step SS4[5].

FIG. 28 is a flowchart illustrating sub-steps SS4[1] to SS4[8′] of step S4.

FIG. 29 is a diagram illustrating an example of how a color unevenness correction value S₀_G, a brightness correction value C₀_G, an ideal output value Aᵢ_G, and a color unevenness correction value S₁_G are calculated in sub-step SS4[5′].

FIG. 30 is a diagram illustrating an example of how the color unevenness correction value S₀_G, the brightness correction value C₀_G, the ideal output value Aᵢ_G, and the color unevenness correction value S₁_G are calculated in sub-step SS4[6′].

FIG. 31 is a view illustrating an example of an operation screen OP1.

FIG. 32 is a view illustrating an example of an operation screen OP2.

FIG. 33 is a view illustrating an example of an operation screen OP3.

FIG. 34 is a flowchart illustrating sub-steps SS4[1]_1 to SS4[1]_7 of sub-step SS4[1].

FIG. 35 is a diagram illustrating an example of target tone values (r, g, b) at grid points DP.

FIG. 36 is a diagram illustrating an example of target tone values (r, g, b) at grid points DP and a target tone value t at a grid point NP adjacent to a boundary between an overlapping region DR and a non-overlapping region NR.

FIG. 37 is a diagram illustrating an example of a method for determining the target tone value t of the grid point NP for which the target tone value t is not determined.

FIG. 38 is a diagram illustrating an example of a method for determining the target tone value t of the grid point NP for which the target tone value t is not determined.

FIG. 39 is a diagram illustrating an example of how the target tone value t is calculated.

FIG. 40 is a diagram illustrating an example of how the target tone value t is calculated.

FIG. 41 is a diagram illustrating an example of how the target tone value t is calculated.

FIG. 42 is a diagram illustrating an example of smoothing.

FIG. 43 is a diagram illustrating an example of smoothing.

FIG. 44 is a diagram illustrating an example of how the target tone value t is smoothed.

FIG. 45 is a diagram illustrating an example of how the target tone value t is smoothed.

FIG. 46 is a diagram illustrating an example of how the target tone value t is smoothed.

FIG. 47 is a diagram illustrating a three-dimensional display of a target value of each grid point NP before smoothing.

FIG. 48 is a diagram illustrating a three-dimensional display of a target value of each grid point NP after the smoothing is completed.

### DESCRIPTION OF EMBODIMENTS

Embodiments for implementing the present disclosure will be described below with reference to the drawings. In the respective drawings, dimensions and scales of the respective parts are made different from real ones as appropriate. Furthermore, the embodiments described below are preferable specific examples of the present disclosure, and various technically preferable restrictions are therefore imposed on the embodiments, but the scope of the present disclosure is not limited to the embodiments unless there is a description that the present disclosure is particularly limited to the embodiments in the following description.

### 1: First Embodiment

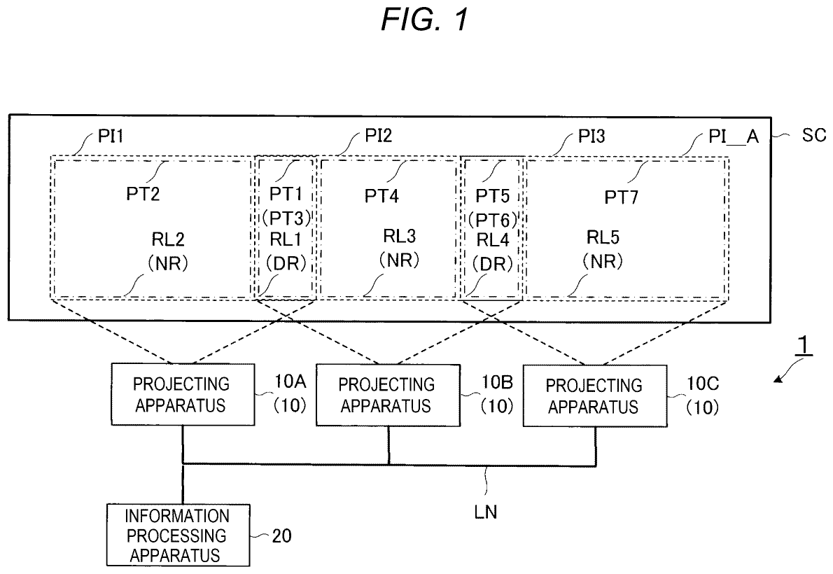

Hereinafter, a projection system 1 according to a first embodiment will be described with reference to FIGS. 1 to 48.

### 1-1: Configuration of First Embodiment

### 1-1-1: Overall Configuration

FIG. 1 is a diagram illustrating an overall configuration of the projection system 1. The projection system 1 includes a projecting apparatus 10A, a projecting apparatus 10B, a projecting apparatus 10C, and an information processing apparatus 20. The projecting apparatus 10A is an example of a “first projecting apparatus”. The projecting apparatus 10B is an example of a “second projecting apparatus”.

The projecting apparatus 10A, the projecting apparatus 10B, the projecting apparatus 10C, and the information processing apparatus 20 are communicably connected to one another via a communication line LN.

The projecting apparatus 10A, the projecting apparatus 10B, and the projecting apparatus 10C project various images or videos onto a projection surface SC. For example, among the projecting apparatus 10A, the projecting apparatus 10B, and the projecting apparatus 10C, the projecting apparatus 10A is a primary projecting apparatus for the projecting apparatus 10B and the projecting apparatus 10C. The projecting apparatus 10B and the projecting apparatus 10C are secondary projecting apparatuses for the projecting apparatus 10A. Specifically, the projecting apparatus 10A transmits various control signals to the projecting apparatus 10B and the projecting apparatus 10C. As a result, the projecting apparatus 10A controls the projecting apparatus 10B and the projecting apparatus 10C. The control signal described above includes various correction values to be described later.

The information processing apparatus 20 supplies various images to the projecting apparatus 10A, the projecting apparatus 10B, and the projecting apparatus 10C. Each of the projecting apparatus 10A, the projecting apparatus 10B, and the projecting apparatus 10C projects the image supplied from the information processing apparatus 20 onto the projection surface SC.

Alternatively, the information processing apparatus 20 may supply an image only to the projecting apparatus 10A, and the projecting apparatus 10A may supply an image to be projected by each projecting apparatus 10 to the projecting apparatus 10B and the projecting apparatus 10C. In the embodiment, when the projecting apparatus 10A to the projecting apparatus 10C are not distinguished from one another, they are referred to as the projecting apparatus 10.

Alternatively, in the projection system 1, each of the projecting apparatus 10A, the projecting apparatus 10B, and the projecting apparatus 10C may read an image to be projected from a storage device 14 provided in each projecting apparatus and project the image onto the projection surface SC. Alternatively, the projecting apparatus 10A may read the image to be projected from the storage device 14 provided in the projecting apparatus 10A, and the projecting apparatus 10A may supply the image to be projected by each projecting apparatus 10 to the projecting apparatus 10B and the projecting apparatus 10C. In this case, the projection system 1 may not necessarily include the information processing apparatus 20.

When the projecting apparatus 10A is the master projecting apparatus 10 and the projecting apparatus 10B and the projecting apparatus 10C are the slave projecting apparatuses 10, the information processing apparatus 20 transmits a control signal for controlling the projecting apparatus 10A to the projecting apparatus 10A. The projecting apparatus 10A may transmit a control signal to the projecting apparatus 10B and the projecting apparatus 10C.

The information processing apparatus 20 is, for example, a personal computer (PC), a tablet, or a smartphone.

In the example illustrated in FIG. 1, the projecting apparatus 10A projects a projection image PI1 on the projection surface SC. The projection image PIL is an example of a “first image”. The projecting apparatus 10B projects a projection image PI2 on the projection surface SC. The projection image PI2 is an example of a “second image”. The projecting apparatus 10C projects a projection image PI3 on the projection surface SC. The projection image PI1, the projection image PI2, and the projection image PI3 are projected in a manner of partially overlapping one another on the projection surface SC, thereby displaying one projection image PI_A as a whole on the projection surface SC. The projection image PI_A is an example of a “third image”.

Specifically, the projection image PI1 includes a part PT1 and a part PT2. The projection image PI2 includes a part PT3, a part PT4, and a part PT5. The projection image PI3 includes a part PT6 and a part PT7. The part PT1 of the projection image PI1 and the part PT3 of the projection image PI2 are projected on the projection surface SC in an overlapping manner. Further, the part PT5 of the projection image PI2 and the part PT6 of the projection image PI3 are projected on the projection surface SC in an overlapping manner.

As a result, the part PT1 of the projection image PI1 and the part PT3 of the projection image PI2 are projected on a region RL1 of the projection surface SC. Only the part PT2 of the projection image PI1 is projected on a region RL2 of the projection surface SC. Only the part PT4 of the projection image PI2 is projected on a region RL3 of the projection surface SC. The part PT5 of the projection image PI2 and the part PT6 of the projection image PI3 are projected on a region RL4 of the projection surface SC. The part PT7 of the projection image PI3 is projected on a region RL5 of the projection surface SC.

Among the plurality of regions RL of the projection surface SC, the region RL1 and the region RL4 are overlapping regions DR. On the other hand, the region RL2, the region RL3, and the region RL5 are non-overlapping regions NR. The overlapping region DR is an example of a “first region”. The non-overlapping region NR is an example of a “second region”.

### 1-1-2: Configuration of Projecting Apparatus

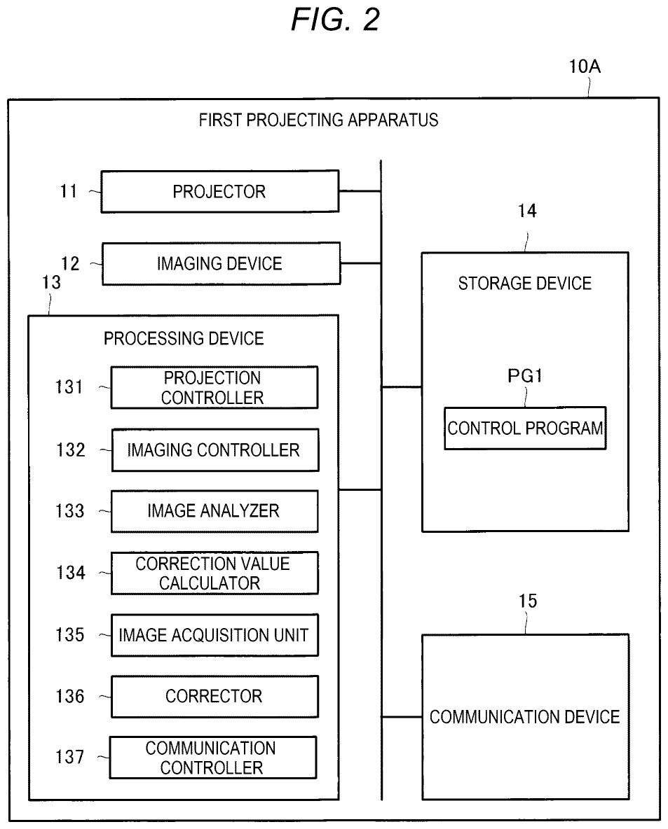

FIG. 2 is a block diagram illustrating the projecting apparatus 10A. The projecting apparatus 10B and the projecting apparatus 10C may have the same configuration as the projecting apparatus 10A. Alternatively, the projecting apparatus 10B and the projecting apparatus 10C may have a configuration in which at least one of an imaging device 12, an imaging controller 132, an image analyzer 133, a correction value calculator 134, an image acquisition unit 135, and a corrector 136, which will be described later, is not provided while having a configuration essential as a projecting apparatus.

The projecting apparatus 10A includes a projector 11, the imaging device 12, a processing device 13, the storage device 14, and a communication device 15.

The elements of the projecting apparatus 10A are coupled to one another via a single bus or multiple buses for information communication. The elements of the projecting apparatus 10A may be configured with one or more instruments, and some elements of the projecting apparatus 10A may be omitted.

The projector 11 is a device that projects various projection images PI on the projection surface SC such as a screen or a wall. The projector 11 projects various projection images PI under the control of the processing device 13. The projector 11 includes, for example, a light source, a projecting lens, a dichroic mirror, a prism, and a liquid crystal panel, modulates light from the light source using the liquid crystal panel, and projects the modulated light onto the projection surface SC via the projecting lens. The light source, the projecting lens, the dichroic mirror, and the prism are examples of a projection optical system.

The imaging device 12 is a device that captures the projection image PI projected onto the projection surface SC. The imaging device 12 captures various images under the control of the processing device 13. The imaging device 12 is, for example, an image sensor.

The processing device 13 is a processor that controls the entire projecting apparatus 10A, and is configured with, for example, a single chip or a plurality of chips. The processing device 13 is configured, for example, with a central processing unit (CPU) including an interface with a peripheral apparatus, an arithmetic device, a register, and so on. A part or all of the functions of the processing device 13 may be implemented by hardware such as a digital signal processor (DSP), an application specific integrated circuit (ASIC), a programmable logic device (PLD), or a field programmable gate array (FPGA). The processing device 13 may include a system on chip (SoC). The processing device 13 executes various types of processing in parallel or in sequence. The processing device 13 or the projecting apparatus 10A is an example of a “computer”. The processing device 13 is an example of an “image processing circuit”.

The storage device 14 is a recording medium that can be read by the processing device 13, and stores a plurality of programs including a control program PG1 to be executed by the processing device 13. Further, the storage device 14 stores a measurement pattern image projected from the projector 11 at the time of correction to be described later. Hereinafter, the measurement pattern image may be referred to as a measurement pattern. The storage device 14 may be configured, for example, with at least one of a read only memory (ROM), an erasable programmable ROM (EPROM), an electrically erasable programmable ROM (EEPROM), and a random access memory (RAM). The storage device 14 may be called a register, a cache, a main memory, a main storage device, or the like.

The communication device 15 is hardware serving as a transmitting and receiving device for communicating with other devices. The communication device 15 is also called, for example, a network device, a network controller, a network card, or a communication module or the like. The communication device 15 may include a connector for wired connection and an interface circuit compatible with the connector. Further, the communication device 15 may include a wireless communication interface. Examples of the connector and the interface circuit for wired connection include those compliant with wired local area network (LAN), IEEE 1394, and a universal serial bus (USB). Further, examples of the wireless communication interface include an interface compliant with wireless LAN and Bluetooth (registered trademark).

The processing device 13 functions as a projection controller 131, the imaging controller 132, the image analyzer 133, the correction value calculator 134, the image acquisition unit 135, the corrector 136, and a communication controller 137 by reading and executing the control program PG1 from the storage device 14. Note that the control program PG1 may be transmitted from another apparatus such as a server that manages the projecting apparatus 10A via a communication network.

The projection controller 131 causes the projector 11 to project the measurement pattern described above onto the projection surface SC. Further, the projection controller 131 causes the projector 11 to project an image acquired from the information processing apparatus 20 by the image acquisition unit 135 to be described later onto the projection surface SC.

The imaging controller 132 causes the imaging device 12 to image reflected light of the measurement pattern projected onto the projection surface SC.

The image analyzer 133 analyzes the reflected light of the measurement pattern captured by the imaging device 12 and calculates a measurement value indicating a color of the measurement pattern in the captured image.

The correction value calculator 134 calculates a correction value to be set in the corrector 136 to be described later based on the measurement value calculated by the image analyzer 133. A specific example of a method of calculating the correction value by the correction value calculator 134 will be described later in the description of an operation of the embodiment with reference to FIGS. 4 to 48.

Hereinafter, the measurement pattern projected by the projector 11 in the embodiment will be described.

For example, a projecting apparatus having a general color adjustment function divides colors from a lowest tone on a black side to a highest tone on a white side in a substantially equal manner, projects color light having a tone color at a division point, and calculates a correction value based on an imaging result obtained by imaging the color light projected onto the projection surface. At this time, the projecting apparatus estimates a color of an intermediate tone between a tone of first color light and a tone of second color light based on an interpolation operation such as spline interpolation, and calculates the correction value based on an estimation result.

Alternatively, for example, a projecting apparatus having a general color adjustment function projects color light having a color based on gray of an intermediate tone and calculates a correction value based on an imaging result obtained by imaging the color light projected on the projection surface. In this case, colors other than gray are estimated based on an interpolation operation using a property of additive color mixture, and a correction value is calculated based on an estimation result.

However, since a color of color light on a low tone side close to black with the tone of 0 is color light obtained by adding light gradually modulated into RGB to color light having black with the tone of 0 on the entire surface, there is a problem that a change in chromaticity is large and an estimation error is large in a measurement method in the related art. Therefore, in the embodiment, color light having a tone color obtained by dividing the chromaticity from 0 to a predetermined tone more finely than the tone equal to or greater than the predetermined tone is projected as the measurement pattern. Accordingly, it is possible to reduce an estimation error in a low tone range close to black as compared with a case where measurement is performed with the same fineness regardless of tone. For example, a range up to 125 tones in a first division section obtained by dividing a tone width from a tone 0 to a tone 1023 into eight sections may be equally divided. The number of divisions may be two or more. Further, it is more preferable to use a gray measurement pattern included between the tone 0 and a predetermined tone and a plurality of measurement patterns obtained by changing one color component of color components of an R component, a G component, and a B component with reference to the gray measurement pattern. As compared with the case of equally dividing a low tone range, the accuracy of estimating a change in chromaticity at the low tone described above is improved.

Returning to FIG. 2, the image acquisition unit 135 acquires an image to be projected from the information processing apparatus 20.

The corrector 136 corrects the image acquired by the image acquisition unit 135 using the correction value calculated by the correction value calculator 134.

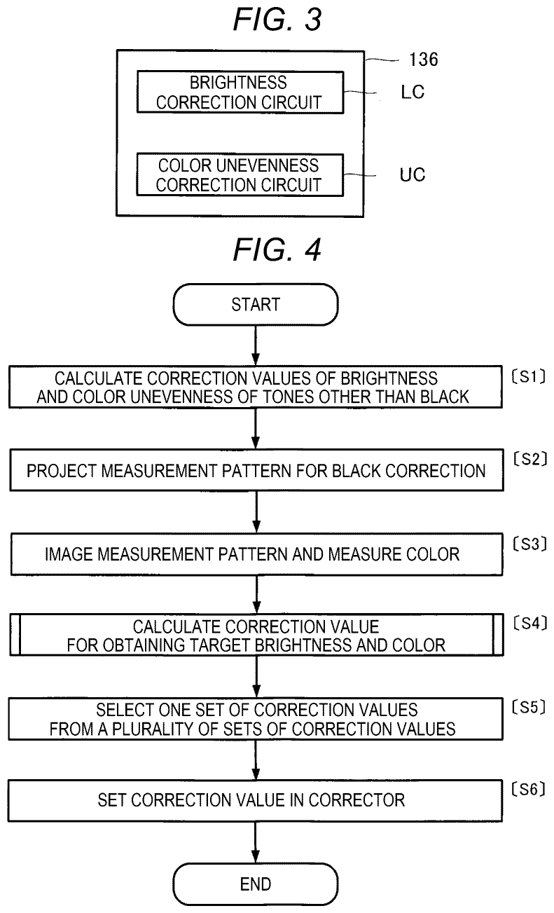

FIG. 3 is a functional block diagram illustrating the corrector 136. The corrector 136 includes a brightness correction circuit LC and a color unevenness correction circuit UC.

The brightness correction circuit LC corrects brightness of the image acquired by the image acquisition unit 135 using the correction value calculated by the correction value calculator 134. The correction includes so-called “black floating” correction. The “black floating” refers to a difference in brightness between the overlapping region DR and the non-overlapping region NR on the projection surface SC when the projecting apparatus 10 projects the projection image PI on the projection surface SC to display a black image with the tone 0 on the projection surface SC. Therefore, it can be said that the “black floating” correction is brightness correction for reducing the difference in brightness between the overlapping region DR and the non-overlapping region NR.

The color unevenness correction circuit UC corrects color unevenness of the image acquired by the image acquisition unit 135 using the correction value calculated by the correction value calculator 134. Details of the brightness correction circuit LC and the color unevenness correction circuit UC will be described later.

In FIG. 2, the projection controller 131 causes the projector 11 to project the image corrected by the corrector 136 as the projection image PI on the projection surface SC.

The communication controller 137 causes the communication device 15 to transmit and receive various types of information to and from an external device. The various types of information include correction values transmitted from the projecting apparatus 10A to each of the projecting apparatus 10B and the projecting apparatus 10C.

### 1-2: Operation in First Embodiment

FIG. 4 is a flowchart illustrating an operation example of the projecting apparatus 10A according to the first embodiment.

In step S1, the projecting apparatus 10A calculates a correction value of brightness and a correction value of color unevenness for tones other than black. Further, the projecting apparatus 10A uses the correction values to adjust brightness and a color of the projection image PI from the projecting apparatuses 10A to 10C to be uniform among the projecting apparatuses 10.

The “black” here is, for example, a color included in a first tone width including the tone 0 when the tone width from the tone 0 which is a minimum tone value to the tone 1023 which is a maximum tone value is divided into N sections. Here, N is an integer of three or more. Hereinafter, for convenience of description, N may be set to 7. In the case of N=7, “black” is a color included in tones from the tone 0 to the tone 146.

The brightness correction described above is a correction for reducing the difference between brightness of the overlapping region DR and brightness of the non-overlapping region NR for tones other than black. The method used for correcting the brightness and the color unevenness may be a method in the related art. For example, the method may be a method of correcting the brightness and the color unevenness by setting one of the regions RL1 to RL5 in FIG. 1 as a target region, and comparing an imaging value indicated by an imaging value obtained by imaging the target region with an imaging value obtained by imaging another region RL.

At this time, it is assumed that adjustment points when the processing device 13 corrects the color unevenness of the projection image PI are, for example, grid points LP of 11 rows×21 columns in the projection image PI. The number of tones is based on a tone at a boundary obtained by dividing a tone width from the tone 0 to the tone 1023 into seven equal sections.

In the processing of step S1, the processing device 13 determines whether each of the grid points LP used as the color unevenness correction circuit UC is included in the overlapping region DR or the non-overlapping region NR. For example, before step S1, the processing device 13 projects an all-white image as a projection image only from the projector 11, and the imaging device 12 of the projecting apparatus 10A captures the all-white image. Next, the processing device 13 projects an all-white image as a projection image only from the projecting apparatus 10B, and the imaging device 12 of the projecting apparatus 10A captures the all-white image. Based on these imaging results, a position of a right side of the all-white image projected from the projecting apparatus 10A and a position of a left side of the all-white image projected from the projecting apparatus 10B are detected, and a region from the position of the right side to the position of the left side is determined as the overlapping region DR in a coordinate system of the captured image. Then, based on a correspondence relationship among a coordinate system of the projecting apparatus 10A, a coordinate system of the projecting apparatus 10B, and the coordinate system of the captured image, which are generated before step S1, the overlapping region DR in the coordinate system of the captured image is converted into the overlapping region DR in the coordinate system of the projecting apparatus 10A and the coordinate system of the projecting apparatus 10B. The processing device 13 determines whether each grid point LP belongs to the overlapping region DR in the coordinate system of the projecting apparatus 10A and the coordinate system of the projecting apparatus 10B based on the captured images of the grid point LP. The correspondence relationship can be calculated by, for example, a well-known calibration technique using a gray code. The coordinate system of the projecting apparatus 10A is a two-dimensional coordinate system of a liquid crystal panel. The same applies to the coordinate system of the projecting apparatus 10B. The same applies to the projecting apparatus 10B and the projecting apparatus 10C.

The above processing is merely an example, and the method of determining whether each of the grid points LP is included in the overlapping region DR or the non-overlapping region NR can be changed as appropriate.

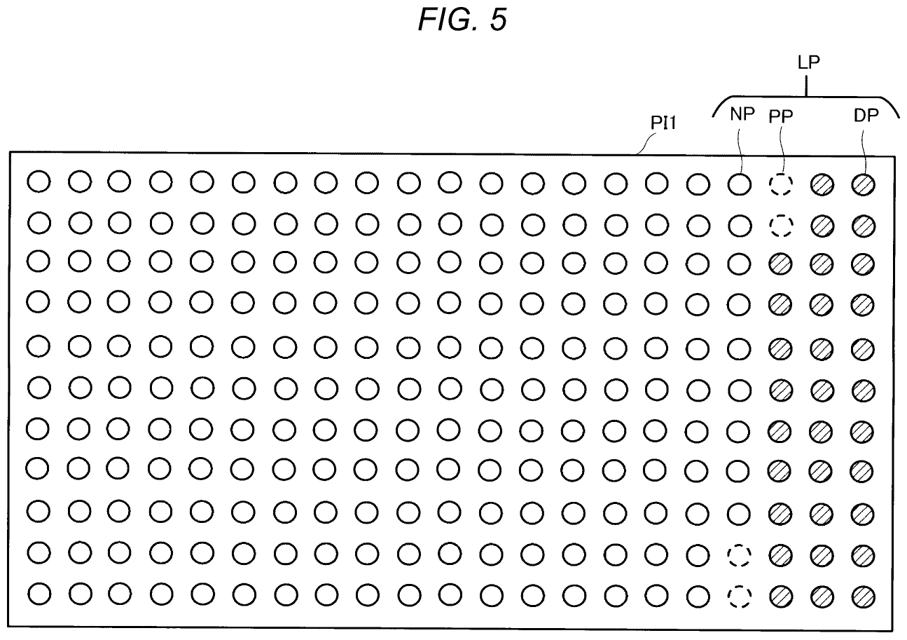

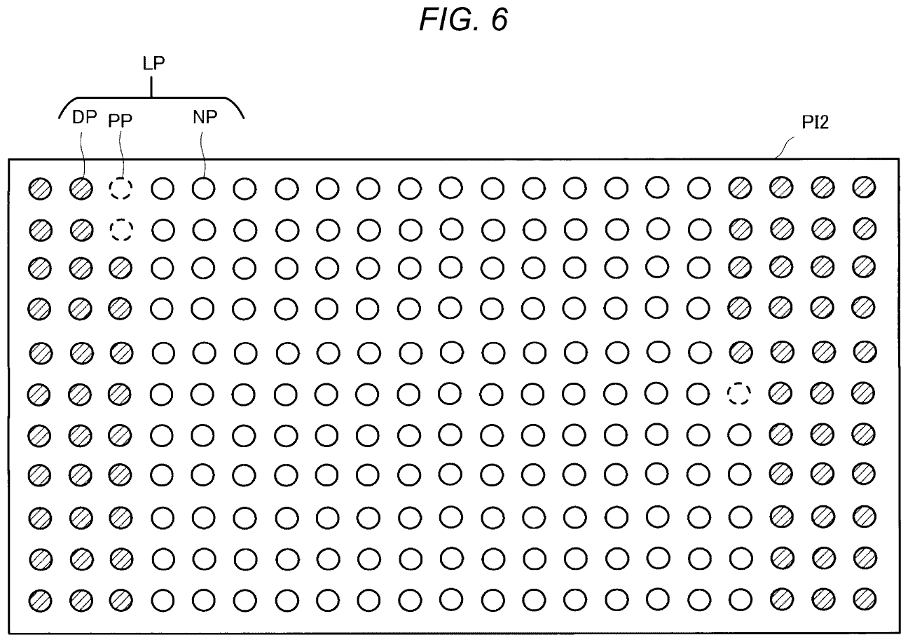

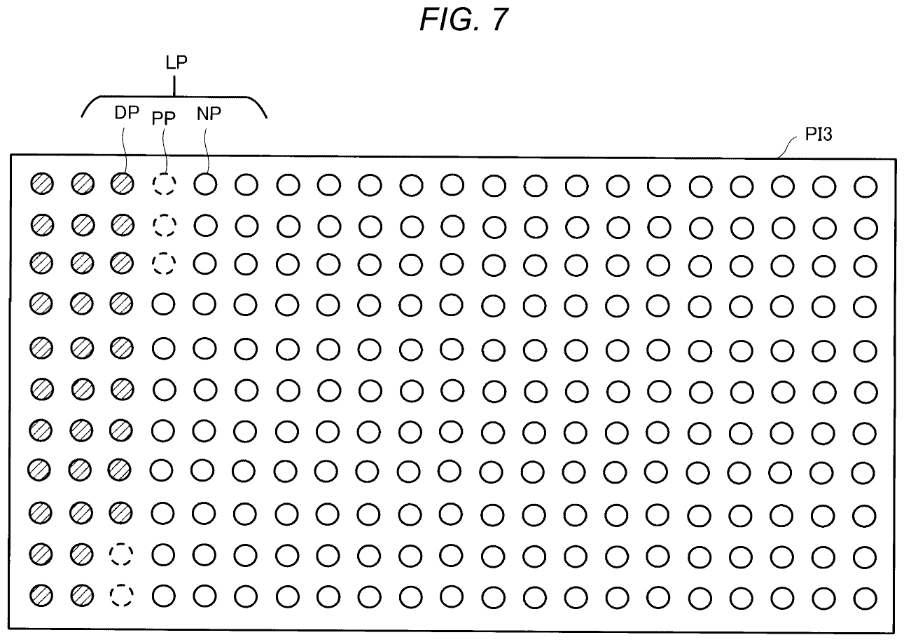

FIGS. 5 to 7 are diagrams illustrating examples of the grid points LP. More specifically, FIG. 5 is a diagram illustrating an example of the grid points LP corresponding to the projection image PI1 projected from the projecting apparatus 10A. FIG. 6 is a diagram illustrating an example of the grid points LP corresponding to the projection image PI2 projected from the projecting apparatus 10B. FIG. 7 is a diagram illustrating an example of the grid points LP corresponding to the projection image PI3 projected from the projecting apparatus 10C.

In FIGS. 5 to 7, the grid points LP include grid points DP, grid points NP, and grid points PP. In these drawings, hatched circles indicate the grid points DP included in the overlapping region DR. White circles indicate the grid points NP included in the non-overlapping region NR. A dotted circle with a contour indicates a grid point PP for which it cannot be determined whether the grid point PP is included in the overlapping region DR or the non-overlapping region NR. There is a measurement value calculated by the image analyzer 133 for each grid point LP illustrated in FIGS. 5 to 7.

In step S2 in FIG. 4, the projecting apparatus 10A projects a measurement pattern for black correction described above. Specifically, the processing device 13 provided in the projecting apparatus 10A functions as the projection controller 131. The processing device 13 reads measurement patterns from the storage device 14 and causes the projector 11 to sequentially project the measurement patterns onto the projection surface SC.

In step S3, the processing device 13 provided in the projecting apparatus 10A functions as the imaging controller 132. The processing device 13 causes the imaging device 12 to image the measurement patterns projected on the projection surface SC. The processing device 13 functions as the image analyzer 133. The processing device 13 analyzes the measurement patterns imaged by the imaging device 12 and calculates measurement values indicating colors of the measurement patterns in a captured image.

First, the processing device 13 uses an interpolation operation to obtain a correspondence relationship between tone values (r, g, b) of color light serving as a measurement pattern projected by the projector 11 and measurement values (R, G, B) representing a color of color light in the captured image, which is calculated by analyzing the color light serving as the measurement pattern captured by the imaging device 12, at each point of the grid points LP.

For the interpolation operation, an appropriate operation may be used according to a type and the number of measurement patterns to be used. For example, the processing device 13 may perform a curve interpolation using a spline curve. Alternatively, the processing device 13 may perform a parabolic interpolation. Alternatively, the processing device 13 may perform a cubic curve interpolation. The cubic curve interpolation is, for example, a cubic interpolation.

The image analyzer 133 converts RGB values into XYZ values using Formula 9 in which a matrix having components of estimated RGB values indicating a color of color light in a captured image is multiplied by a conversion matrix unique to the imaging device 12. As a result, the image analyzer 133 can estimate output values XYZ for any one tone.

Further, the image analyzer 133 calculates a brightness component Y and a chromaticity component u′v′ by converting the estimated XYZ values into Yu′v′ values using the following Formula 1.

$${u}^{′} = \frac{4 X}{X + 15 Y + 3 Z} , {v}^{′} = \frac{9 Y}{X + 15 Y + 3 Z} \qquad [ 1 ]$$

Returning to FIG. 4, in step S4, the processing device 13 provided in the projecting apparatus 10A functions as the correction value calculator 134. The processing device 13 calculates a correction value to be set in each of the brightness correction circuit LC and the color unevenness correction circuit UC so that brightness of black after correction becomes target brightness when viewed from the imaging device 12, color unevenness of black after correction is prevented, and chromaticity becomes uniform when viewed from the imaging device 12.

In the embodiment, the processing device 13 calculates a plurality of types of correction values. Hereinafter, the purpose of calculating a plurality of types of correction values will be described.

In a correction function in the related art, only one correction value for making color unevenness or brightness uniform is calculated and set in a correction circuit based on a captured image such as a measurement pattern. When a plurality of projecting apparatuses are used, a uniform brightness correction value is applied to the non-overlapping regions NR in order to correct “black floating”.

When the color unevenness of black is corrected using the correction function in the related art, black having the lowest luminance is corrected to black having higher luminance, and thus black becomes bright in a projection image. Therefore, correction accuracy of color unevenness and brightness of black after correction are in a trade-off relationship.

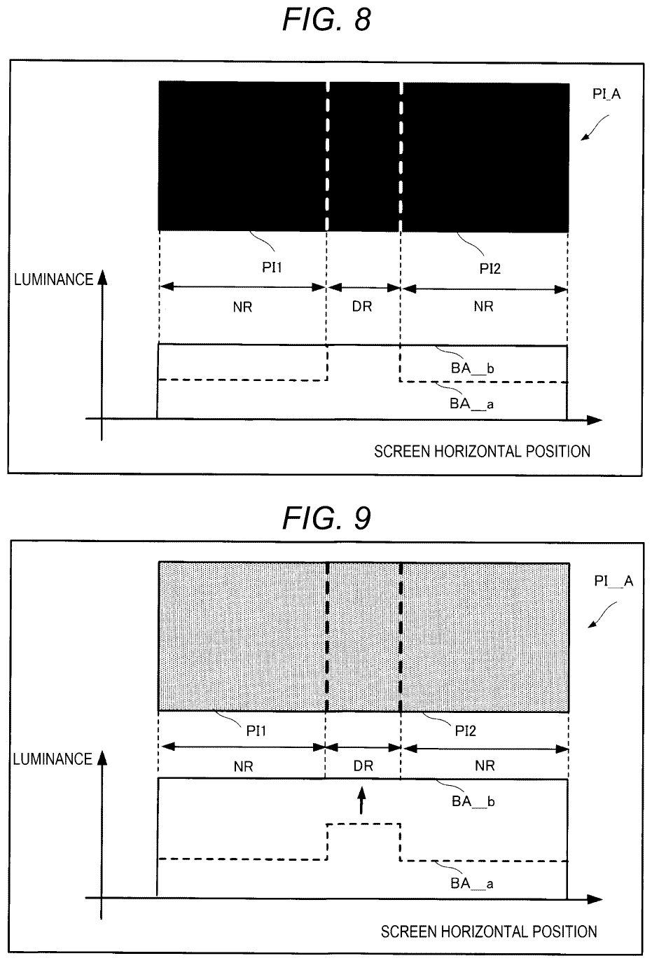

FIG. 8 is a diagram illustrating a projection image PI_A corrected with priority given to a contrast ratio, and pre-correction luminance BA_a and post-correction luminance BA_b in the projection image PI_A. FIG. 9 is a diagram illustrating a projection image PI_A corrected with priority given to accuracy of color unevenness correction, and pre-correction luminance BA_a and post-correction luminance BA_b in the projection image PI_A. As illustrated in FIG. 8, when an image is corrected with priority given to the contrast ratio, color unevenness remains in the overlapping region DR. On the other hand, as illustrated in FIG. 9, when an image is corrected with priority given to the accuracy of color unevenness, the contrast ratio decreases.

However, depending on a use environment of a projecting apparatus or a type of projection content, for example, as in the case of projecting contents whose entire surface is black or dark, non-uniformity of black is likely to be noticed, and thus it may be preferable to accurately correct the color unevenness, whereas it may be preferable to make black dark as in a case where the projecting apparatus is used in a dark environment. A method of calculating only one correction value in the related art cannot cope with a problem that an appropriate correction value varies depending on the use environment and the type of projection content.

There is another problem that, when luminance unevenness of color light projected from one projecting apparatus is large, the magnitude of the “black floating” varies depending on a location in the projection image PI. Therefore, in a “black floating” correction method in the related art, a luminance gradient occurs between the overlapping region DR and the non-overlapping region NR, and a contour may be enhanced.

FIGS. 10 to 12 are diagrams illustrating luminance gradients. In FIG. 10, a one-dot chain line indicates color unevenness correction values UA. The numbers at both ends of the one-dot chain line are values of the color unevenness correction values UA. A thick solid line indicates luminance BA which is an ideal output value.

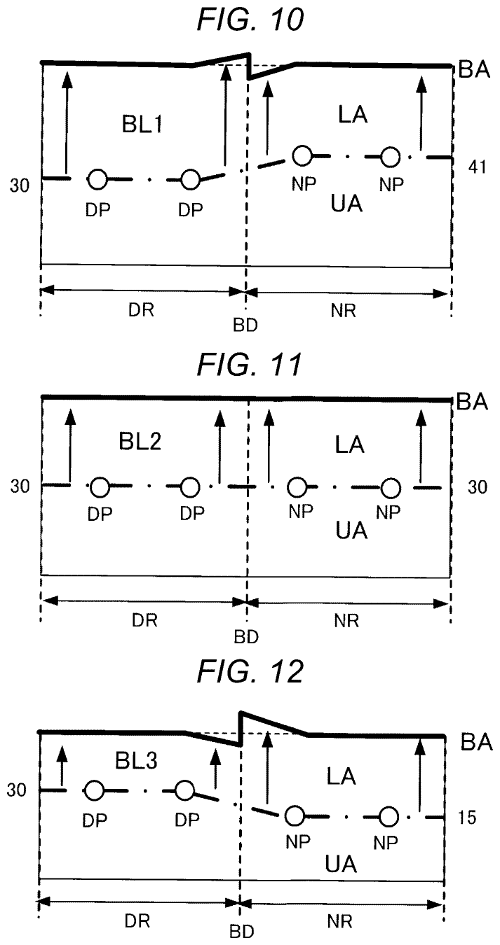

In the overlapping region DR in FIG. 10, the luminance BA is a value obtained by adding luminance BL1 of “black floating” light projected from the adjacent projecting apparatuses 10 to the color unevenness correction value UA. In the overlapping region DR in FIG. 11, the luminance BA is a value obtained by adding luminance BL2 of “black floating” light projected from the adjacent projecting apparatuses 10 to the color unevenness correction value UA. In the overlapping region DR in FIG. 12, the luminance BA is a value obtained by adding luminance BL3 of “black floating” light projected from the adjacent projecting apparatuses 10 to the color unevenness correction value UA. Here, BL1>BL2>BL3.

As illustrated in FIGS. 10 to 12, in the non-overlapping region NR, the luminance BA is a value obtained by adding the brightness correction value LA to the color unevenness correction value UA.

The color unevenness correction value UA is different between the overlapping region DR and the non-overlapping region NR. Further, the color unevenness correction value UA is linearly interpolated between the grid point DP included in the overlapping region DR and the grid point NP included in the non-overlapping region NR.

As illustrated in FIG. 11, an ideal luminance distribution is a distribution in which the luminance BA of the overlapping region DR and the luminance BA of the non-overlapping region NR have the same value and no luminance gradient occurs. However, the luminance BL1 of the “black floating” light varies depending on a location of the overlapping region DR, and the color unevenness correction value UA varies depending on a location of the non-overlapping region NR. On the other hand, the brightness correction value LA is uniformly the same value in the non-overlapping region NR. Therefore, as illustrated in FIGS. 10 and 12, a step occurs in the luminance BA between the overlapping region DR and the non-overlapping region NR. When there is a step in the luminance BA due to the feature of human vision, a contour appears to be present at a location where the step occurs.

In the calculation of a correction value at the grid point LP illustrated in FIGS. 10 to 12, particularly when an interval between the grid points LP is narrow, a luminance gradient between the grid point DP included in the overlapping region DR and the grid point NP included in the non-overlapping region NR has a steep angle, and thus the contour may be further enhanced.

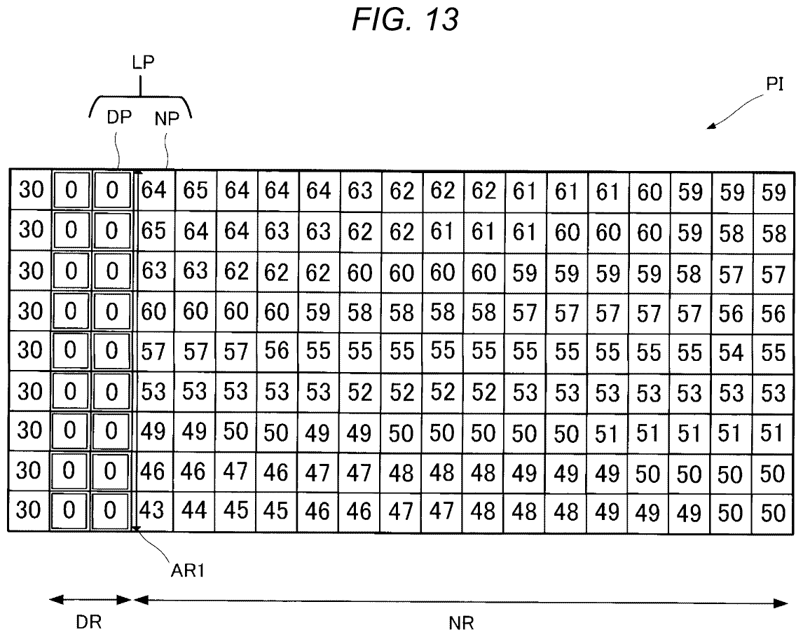

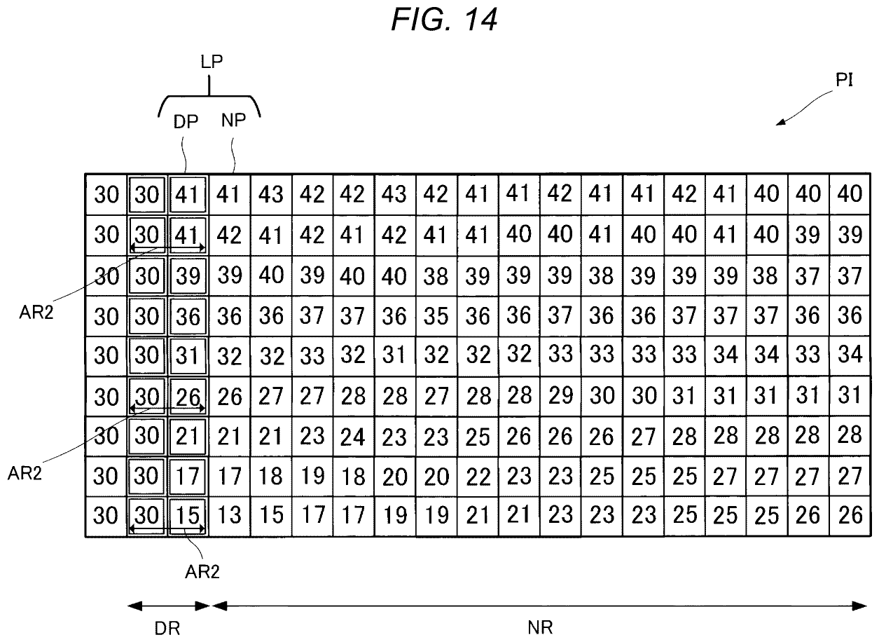

FIG. 13 is a diagram illustrating an example of the luminance BA which is an ideal output value for making brightness uniform between the overlapping region DR and the non-overlapping region NR at the grid points LP included in the projection image PI. FIG. 14 is a diagram illustrating an example of the color unevenness correction value UA when a correction value is divided into the brightness correction value LA and the color unevenness correction value UA based on the luminance BA illustrated in FIG. 13. As indicated by an arrow AR1 in FIG. 13, when there is luminance unevenness in a boundary direction between the overlapping region DR and the non-overlapping region NR at the grid point NP adjacent to the grid point DP, a luminance gradient occurs as indicated by an arrow AR2 in FIG. 14.

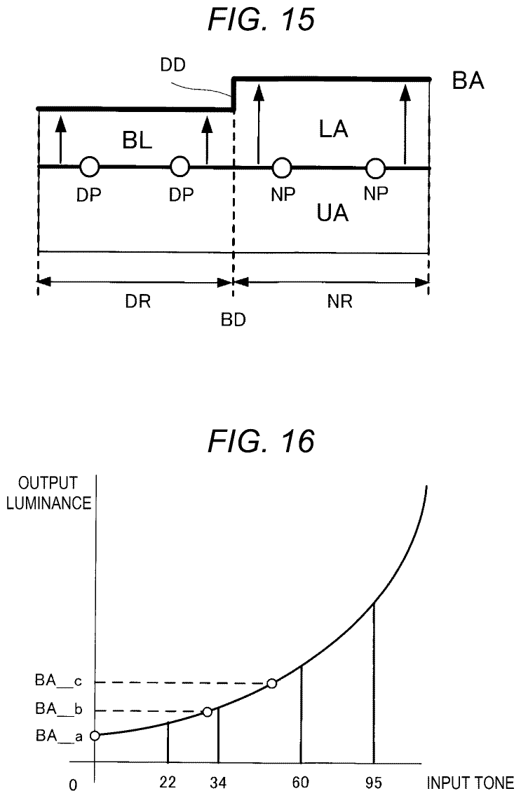

Therefore, it is considered to use a correction method of intentionally leaving a step DD of the luminance BA which is an ideal output value so that the luminance gradient for enhancing a contour does not occur near the boundary line between the overlapping region DR and the non-overlapping region NR. FIG. 15 is a diagram illustrating a correction method of leaving a step DD. In FIG. 15, the step DD of the luminance BA is left on a boundary line BD between the overlapping region DR and the non-overlapping region NR, but each of the luminance BA in the overlapping region DR and the luminance BA in the non-overlapping region NR is flat, and no luminance gradient occurs. In this case, the contour enhancement is alleviated by the processing device 13 intentionally performing correction so that the luminance gradient does not occur.

However, a level of contour enhancement and a level at which the step of the luminance BA is noticed vary depending on a subjective view of a user. Therefore, the technique in the related art in which only one correction value is calculated cannot cope with the problem that an appropriate correction value varies depending on a use situation of a projecting apparatus and a type of projection content.

Therefore, in the embodiment, regarding the color correction of black, the projecting apparatus 10 calculates a correction value based on a plurality of parameters, and performs the correction using a correction value selected by a user.

First, a first parameter is a parameter indicating whether to give priority to the contrast ratio or the color unevenness in the projection image PI_A. Specifically, the first parameter is used to designate whether to set brightness of the projection image PI_A to brightness with priority given to the contrast ratio, or whether to set brightness of the projection image PI_A to brightness with priority given to accuracy of the correction of color unevenness of black, or whether to set brightness of the projection image PI_A to brightness between the above two kinds of brightness. The processing device 13 calculates a plurality of types of target values for a target value of brightness after correction corresponding to the first parameter, and calculates a correction value for the target value.

When the first parameter indicates the brightness with priority given to the contrast ratio, the processing device 13 performs correction only by increasing an R component and a B component without brightening the entire black. The reason why the processing device 13 increases only the R component and the B component and does not increase the G component is that when all the three components of the R component, the B component, and the G component are increased, black is rapidly brightened. When the G component is also increased in addition to the R component and the B component, the processing device 13 sets a limit on an increase width of the G component.

When the first parameter indicates the brightness with priority given to the accuracy of the correction of the color unevenness of black, the processing device 13 slightly brightens black within a range in which the color unevenness of black can be corrected with high accuracy. Specifically, the processing device 13 brightens black by a predetermined constant amount, increases or decreases all the color components of the R component, the G component, and the B component, and corrects the color unevenness.

When the first parameter indicates intermediate brightness between the two kinds of brightness described above, the processing device 13 makes the black slightly brighter than the brightness in the case where the first parameter indicates the brightness with priority given to the contrast ratio. The brightness is darker than the brightness in the case where the first parameter indicates the brightness with priority given to the accuracy of the correction of the color unevenness of black. In this case, since an adjustment width of the black is narrower than that in the case where the first parameter indicates the brightness with priority given to the accuracy of the correction of the color unevenness of black, there is a possibility that the correction accuracy of the black is lowered as compared with the case where the first parameter indicates the brightness with priority given to the contrast ratio, but as compared with the case, the deterioration of the contrast ratio is small.

FIG. 16 is a diagram illustrating an example of luminance BA_a which is a target value when the first parameter indicates the brightness with priority given to the contrast ratio, luminance BA_c which is a target value when the first parameter indicates the brightness with priority given to the accuracy of the correction of the color unevenness of black, and luminance BA_b which is a target value when the first parameter indicates the brightness between the above two kinds of brightness. In the example illustrated in FIG. 16, the luminance BA_a is output luminance when an input tone is the tone 0 in the same Y curve as described above. The luminance BA_b is output luminance when an input tone is a tone between the tone 22 and the tone 34 in the y curve. The luminance BA_c is output luminance when an input tone is a tone between the tone 34 and the tone 95 in the y curve. Values of the input tone corresponding to the luminance BA_b and the luminance BA_c in FIG. 16 are examples, and may be values different from those in FIG. 16.

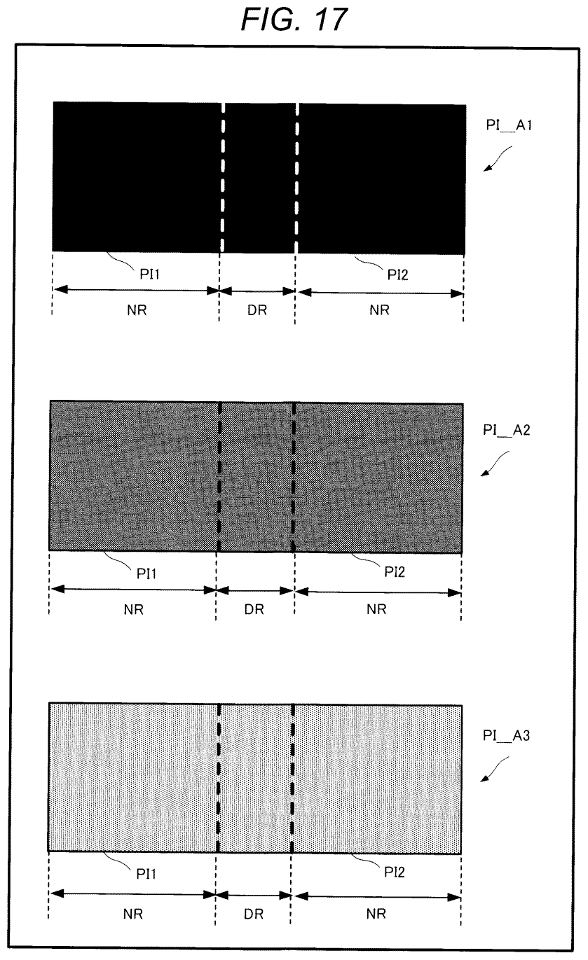

FIG. 17 is a diagram illustrating an example of image the projection PI_A after correction. More specifically, in FIG. 17, a projection image PI_A1 is a projection image when luminance which is a target value is the luminance BA_a in FIG. 16. A projection image PI_A2 is a projection image when luminance which is a target value is the luminance BA_b in FIG. 16. A projection image PI_A3 is a projection image when luminance which is a target value is the luminance BA_c in FIG. 16.

As illustrated in FIG. 17, black of the projection image PI_A1 is the darkest, and black of the projection image PI_A3 is the brightest. Black of the projection image PI_A2 is intermediate dark black between the black of the projection image PI_A1 and the black of the projection image PI_A3.

After the three kinds of target values are calculated as ideal output values corresponding to the three kinds of first parameters, the processing device 13 calculates ideal color unevenness correction values of the overlapping region DR for the luminance BA_a, the luminance BA_b, and the luminance BA_c as target values. Next, the processing device 13 calculates correction values of the non-overlapping region NR corresponding to the ideal color unevenness correction values of the overlapping region DR so that the non-overlapping region NR has the same chromaticity and the same luminance as those of the overlapping region DR after the correction.

The processing device 13 divides a correction value corresponding to the target value into the brightness correction value and the color unevenness correction value based on a second parameter. The second parameter is a parameter indicating a level at which the boundary between the overlapping region DR and the non-overlapping region NR in the projection image PI_A is noticed. It can also be said that the second parameter is a parameter indicating uniformity of brightness in the projection image PI after black is corrected based on the first parameter. The second parameter is used to designate whether to give priority to the uniformity of brightness between the overlapping region DR and the non-overlapping region NR, or whether to give priority to flatness of brightness in each of the overlapping region DR and the non-overlapping region NR, or whether to take an intermediate value between the above two case.

When the second parameter indicates that priority is given to the uniformity of brightness, the processing device 13 corrects “black floating” using both the brightness correction circuit LC and the color unevenness correction circuit UC illustrated in FIG. 3. A correction method in this case corresponds to the diagram of the luminance gradient illustrated in FIG. 10 or 12, and the vicinity of the boundary line BD of the projection image PI_A may be contour-enhanced.

When the second parameter indicates that priority is given to the flatness of brightness in each of the overlapping region DR and the non-overlapping region NR, the processing device 13 corrects “black floating” using both the brightness correction circuit LC and the color unevenness correction circuit UC illustrated in FIG. 3. A correction method in this case corresponds to the diagram of the luminance gradient illustrated in FIG. 15, and the vicinity of the boundary line BD of the projection image PI_A is not likely to be contour-enhanced, but brightness is different between the overlapping region DR and the non-overlapping region NR.

When the second parameter indicates an intermediate value between the above two cases, the processing device 13 calculates both correction values of the correction value when the second parameter indicates that priority is given to the uniformity of brightness and the correction value when the second parameter indicates that priority is given to the flatness of brightness in each of the overlapping region DR and the non-overlapping region NR, and sets an average value of the two correction values as a correction value when the second parameter indicates an intermediate value. In this case, the luminance gradient becomes gentler than in the case where the second parameter indicates that priority is given to the uniformity of brightness, and a level of contour enhancement is lowered. In this case, a difference in brightness between the overlapping region DR and the non-overlapping region NR is also reduced by half as compared with the case where the second parameter indicates that priority is given to the flatness of brightness in each of the overlapping region DR and the non-overlapping region NR.

As described above, the processing device 13 performs three kinds of correction based on the first parameter and performs three kinds of correction based on the second parameter, thereby calculating a total of 3×3=9 correction values. However, the processing device 13 may calculate three correction values based on only the first parameter, or may calculate three correction values based on only the second parameter. The number of the first parameters may be two or more, four, or ten. The same applies to the second parameter. The number of the first parameters may be different from the number of the second parameters, such as two first parameters and three second parameters.

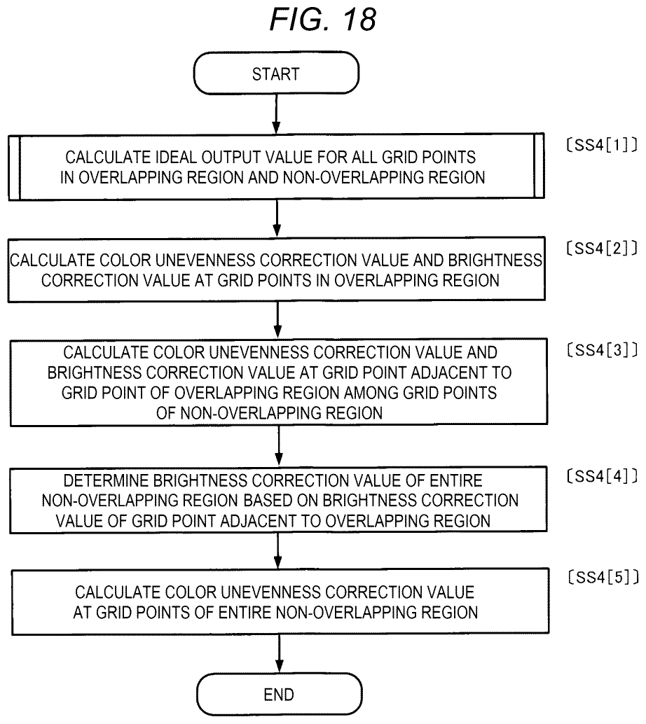

FIG. 18 is a flowchart illustrating sub-steps SS4[1] to SS4[5] of step S4 when the second parameter indicates that priority is given to the uniformity of brightness.

In sub-step SS4[1], the processing device 13 calculates an ideal output value at all the grid points LP in the overlapping region DR and the non-overlapping region NR. Specifically, the processing device 13 calculates an ideal output value for correcting color unevenness in the overlapping region DR as a correction value at the grid point DP included in the overlapping region DR. Further, the processing device 13 corrects color unevenness in the non-overlapping region NR and calculates an ideal value for adjusting brightness of the non-overlapping region NR to brightness of the overlapping region DR, as a correction value at the grid point LP included in the non-overlapping region NR. After the above processing, the processing device 13 decomposes the ideal output values at the grid point DP included in the overlapping region DR and the grid point NP included in the non-overlapping region NR into a correction value to be set in the brightness correction circuit LC and a correction value to be set in the color unevenness correction circuit UC. The ideal output value is an example of a “target tone value”.

A method of calculating the “ideal output value” will be described later in “1-3: Supplement (Ideal Output Value Calculation Method)”.

Here, specifications of the brightness correction circuit LC controlled by the brightness correction circuit LC and the color unevenness correction circuit UC controlled by the color unevenness correction circuit UC will be described.

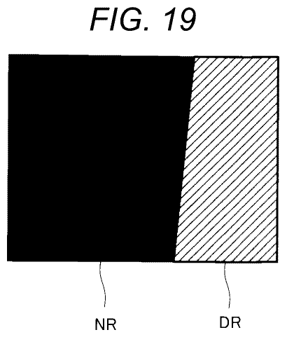

FIG. 19 is a diagram illustrating an example of a correction region of the brightness correction circuit LC. In FIG. 19, each of the overlapping region DR and the non-overlapping region NR is a correction region to be corrected by the brightness correction circuit LC. The brightness correction circuit LC functions as a circuit that corrects so-called “black floating” when black is to be corrected. The brightness correction circuit LC can set any shape as illustrated in FIG. 19 as a correction region. The brightness correction circuit LC can set a brightness correction value C₀, which is a uniform adjustment amount, for each of the overlapping region DR and the non-overlapping region NR illustrated in FIG. 19.

On the other hand, the color unevenness correction circuit UC can set a correction value for each of the discrete grid points LP illustrated in FIGS. 5 to 7. Further, the color unevenness correction circuit UC can set a color unevenness correction value S as an adjustment value for each discrete tone. Here, for example, the color unevenness correction value S is set for eight tones. Specifically, the color unevenness correction value S at the tone 0 is denoted by S₀, a color unevenness correction value at the tone 146 is denoted by S₁, and a color unevenness correction value at the tone 1023 is denoted by S₇. Further, the color unevenness correction values S at tones among the tone 0, the tone 146 . . . the tone 1023 are determined by a linear interpolation.

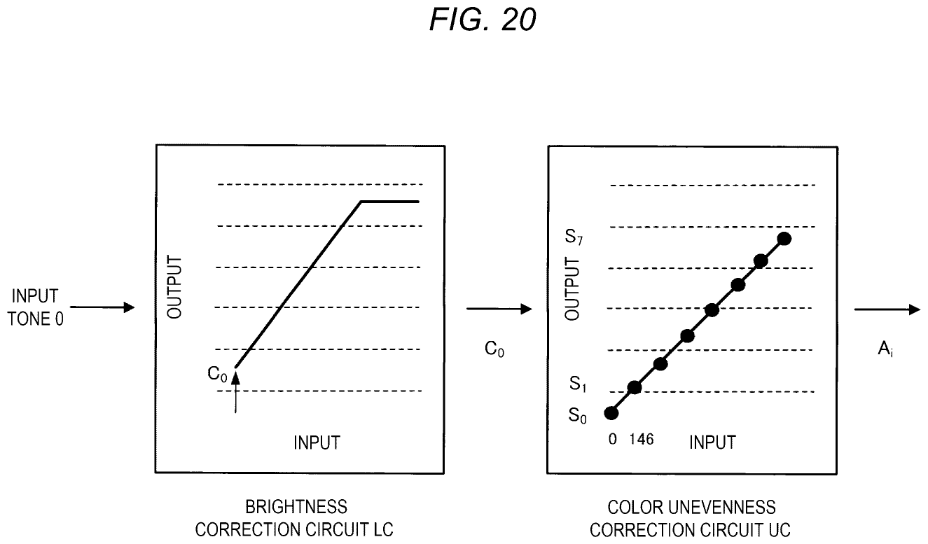

FIG. 20 is a diagram illustrating a processing procedure of the brightness correction circuit LC and the color unevenness correction circuit UC. As illustrated in FIG. 20, when an image of the tone 0 is input to the brightness correction circuit LC as an input image, the brightness correction value C₀ is added to the input value. In the case of the tone 0, the brightness correction value output from the brightness correction circuit LC is C₀. When the brightness correction value C₀ is output from the brightness correction circuit LC to the color unevenness correction circuit UC, the color unevenness correction circuit UC performs a linear interpolation between a point at which the x coordinate is the tone 0 and the y coordinate is the color unevenness correction value S₀ and a point at which the x coordinate is the tone 146 and the y coordinate is the color unevenness correction value S₁, thereby obtaining the following Formula 2. An output value Aᵤ Of the color unevenness correction circuit UC is calculated by the following Formula 2. The color unevenness correction value S₁ was calculated in step S₁ of FIG. 4.

$${A}_{u} = \frac{{S}_{1} - {S}_{0}}{146 - 0} * {C}_{0} + {S}_{0} \qquad [ 2 ]$$

At the grid point LP, the output value Aᵤ is calculated by using the above Formula 2. A linearly interpolated value is calculated for a pixel between the grid points LP.

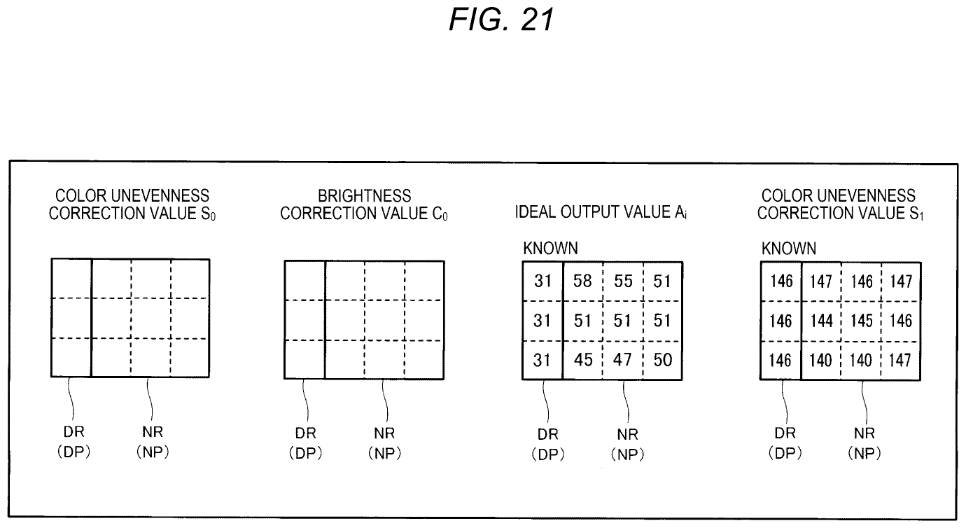

FIG. 21 is a diagram illustrating an example of how the color unevenness correction value S₀, the brightness correction value C₀, an ideal output value Aᵢ, and the color unevenness correction value S₁ are calculated in sub-step SS4[1]. In FIG. 21, in order to simplify the description, it is assumed that the grid points DP included in the overlapping region DR have one column and three rows and the grid points NP included in the non-overlapping region NR have three columns and three rows. As illustrated in FIG. 21, at a stage where the sub-step SS4[1] is completed, the ideal output value Aᵢ and the color unevenness correction value S₁ are calculated at all the grid points DP and all the grid points NP. On the other hand, the color unevenness correction value S₀ and the brightness correction value C₀ are not calculated at any grid point DP and any grid point NP.

The numerical values illustrated in FIG. 21 are integers, but are integers for convenience of description. Alternatively, values corresponding to the grid points DP and the grid points NP may be decimal values. The same applies to the following drawings.

In sub-step SS4[2] of FIG. 18, the processing device 13 calculates the color unevenness correction value S₀ and the brightness correction value C₀ at the grid points DP included in the overlapping region DR. Specifically, the processing device 13 divides the ideal output value Aᵢ at the grid points DP included in the overlapping region DR into the color unevenness correction value S₀ and the brightness correction value C₀.

The processing device 13 determines the brightness correction value C₀=C^{Lap} in the overlapping region DR in advance, and calculates the color unevenness correction value S₀=S₀^{Lap} at the tone 0 so that the output value Aᵤ, which is a final output value, becomes an ideal output value Aᵢ=A^{Lap}. The brightness correction value C₀=C^{Lap}, the ideal output value Aᵢ=A^{Lap}, and the color unevenness correction value S₁=S₁^{Lap} at the tone 146 are known, and when these values are substituted into Formula 2, Formula 3 is obtained. The color unevenness correction value S₀=S₀^{Lap} is calculated by transforming Formula 3 into Formula 4. In FIG. 21, the ideal output value Aᵢ included in the overlapping region DR is the ideal output value Aᵢ=A^{Lap} described above.

The color unevenness correction value S₀=S₀^{Lap} in the overlapping region DR is an example of a “first color unevenness correction value”.

$${A}^{Lap} = \frac{{S}_{1}^{Lap} - {S}_{0}^{Lap}}{146 - 0} * {C}^{Lap} + {S}_{0}^{Lap} \qquad [ 3 ]$$

$${S}_{0}^{Lap} = \frac{{S}_{1}^{Lap} {C}^{Lap} - 146 {A}^{Lap}}{{C}^{Lap} - 146} \qquad [ 4 ]$$

Note that the brightness correction value C₀ of the overlapping region DR may be set to C^{Lap}=0, and the color unevenness correction value S₀ of the tone 0 may be set to S₀^{Lap}=A^{Lap}.

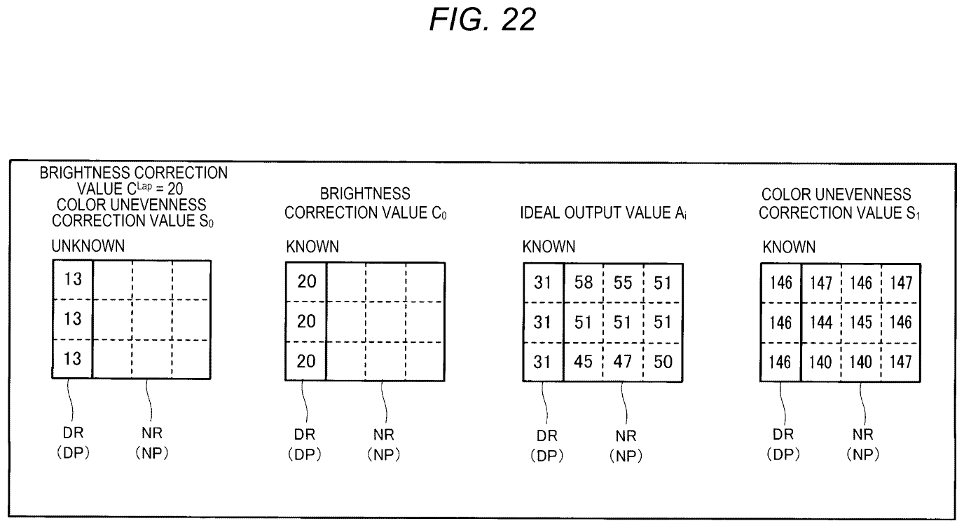

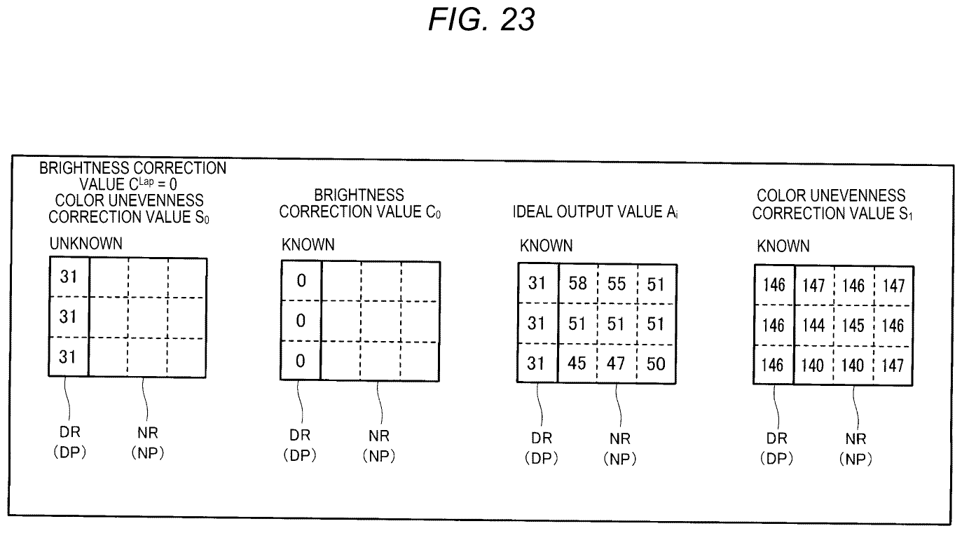

FIGS. 22 and 23 are diagrams illustrating examples of how the color unevenness correction value S₀, the brightness correction value C₀, the ideal output value Aᵢ, and the color unevenness correction value S₁ are calculated in sub-step SS4[2]. FIG. 22 illustrates a diagram when C^{Lap}=20. FIG. 23 illustrates a diagram when C^{Lap}=0. As illustrated in FIGS. 22 and 23, at a stage where the sub-step SS4[2] is completed, the ideal output value Aᵢ and the color unevenness correction value S₁ are calculated at all the grid points DP and all the grid points NP. Further, the color unevenness correction value S₀ and the brightness correction value C₀ are calculated at the grid points DP included in the overlapping region DR. As described above, the brightness correction value C₀ and the color unevenness correction value S₀ at the grid points DP included in the overlapping region DR are determined at the stage of sub-step SS4[2].

In sub-step SS4[3] of FIG. 18, the processing device 13 calculates the color unevenness correction value S₀ and the brightness correction value C₀ at the grid point NP adjacent to the grid point DP included in the overlapping region DR across the boundary between the non-overlapping region NR and the overlapping region DR, among the grid points NP included in the non-overlapping region NR.

When the grid point DP and the grid point NP are adjacent to each other, the processing device 13 calculates the brightness correction value C₀ of the grid point NP so that the color unevenness correction value S₀ of the tone 0 at the grid point NP is the same as the color unevenness correction value S₀ of the tone 0 at the grid point DP.

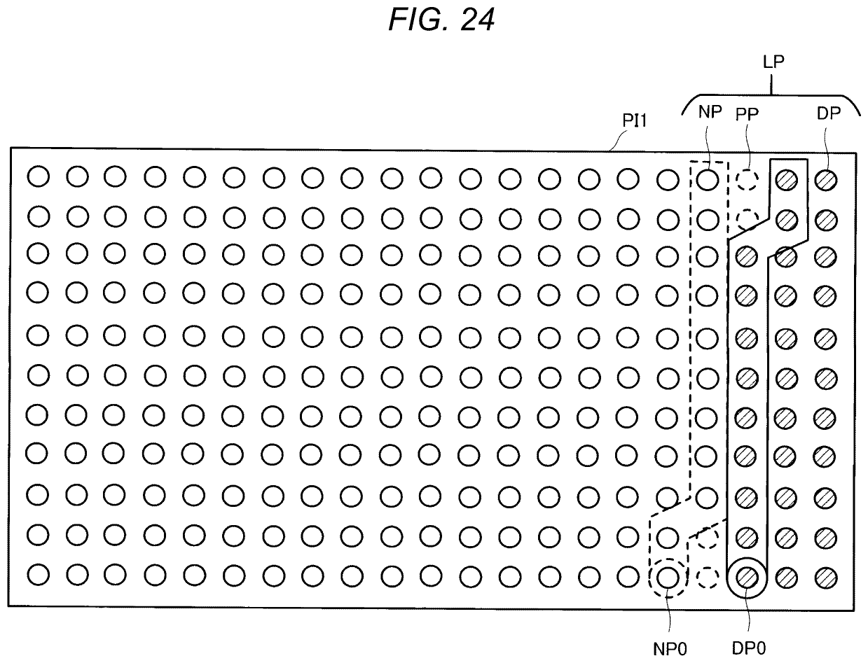

FIG. 24 is a diagram illustrating processing content in sub-step SS4[3]. The projection image PI1 illustrated in FIG. 24 corresponds to the projection image PI1 illustrated in FIG. 5.

In FIG. 24, the grid points NP surrounded by a dotted line are adjacent to the overlapping region DR across the boundary between the non-overlapping region NR and the overlapping region DR. In sub-step SS4[3], the processing device 13 calculates correction values at these grid points NP. The grid points DP surrounded by a solid line are grid points DP in the overlapping region DR adjacent to the grid points NP.

When calculating the brightness correction value C₀ at the grid point NP0 illustrated in FIG. 24, the processing device 13 calculates the brightness correction value C₀=C^{NonLap} at a grid point NP0 so that the color unevenness correction value S₀ at the grid point NP0 is the same as the color unevenness correction value S₀=S₀^{Lap} at a grid point DP0. The grid point NP0 and the grid point DP0 are located in the same row of the grid and are adjacent to each other in a row direction. When the grid point PP for which it cannot be determined whether the grid point PP belongs to the overlapping region DR or the non-overlapping region NR is present between the grid point NP0 and the grid point DP0, the grid point DP0 and the grid point NP0 closest to each other in either the row direction or the column direction across the boundary between the non-overlapping region NR and the overlapping region DR are treated as grid points adjacent to each other.

The ideal output value Aᵢ=A^{NonLap}, the color unevenness correction value S₁=S₁^{NonLap} at the tone 146, and the color unevenness correction value S₀=S₀^{Lap} are known, and when these values are substituted into Formula 2, Formula 5 is obtained. The brightness correction value C₀=C^{NonLap} is calculated by transforming Formula 5 into Formula 6.

$${A}^{NonLap} = \frac{{S}_{1}^{NonLap} - {S}_{0}^{Lap}}{146 - 0} * {C}^{NonLap} + {S}_{0}^{Lap} \qquad [ 5 ]$$

$${C}^{NonLap} = \frac{146 ( {A}^{NonLap} - {S}_{0}^{Lap} )}{{S}_{1}^{NonLap} - {S}_{0}^{Lap}} \qquad [ 6 ]$$

The processing device 13 executes the same calculation for all the grid points NP surrounded by the dotted line, and calculates the brightness correction value C₀=C^{NonLap} of each grid point NP.

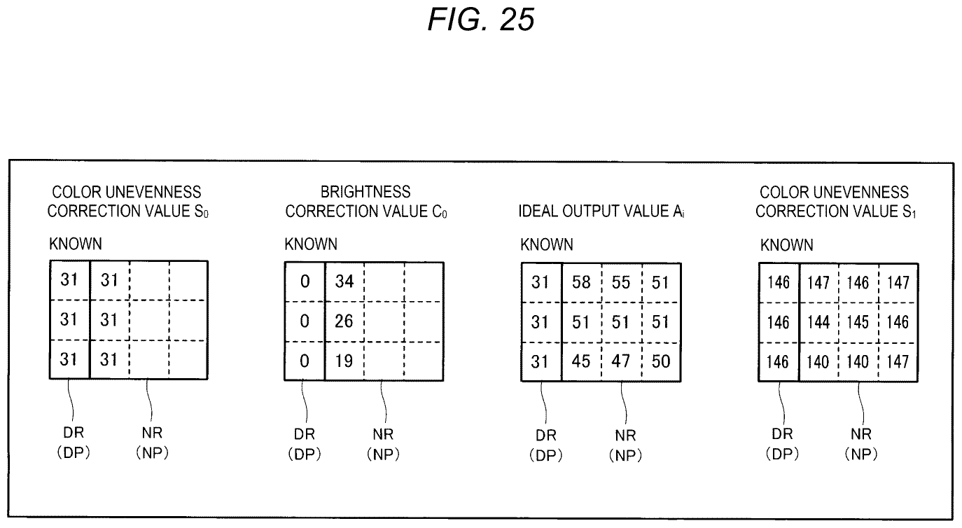

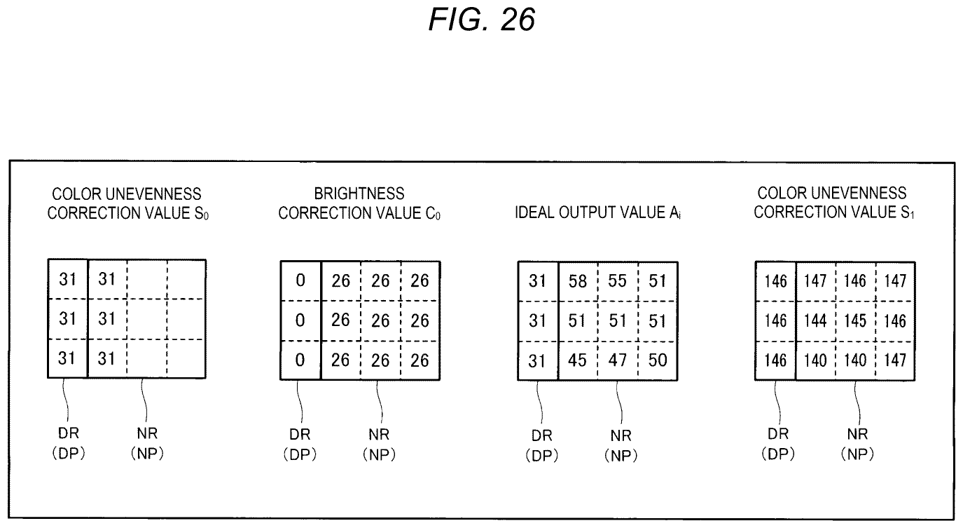

FIG. 25 is a diagram illustrating an example of how the color unevenness correction value S₀, the brightness correction value C₀, the ideal output value Aᵢ, and the color unevenness correction value S₁ are calculated in sub-step SS4[3].

In FIG. 25, the ideal output value Aᵢ of the grid point NP adjacent to the grid point DP among the grid points NP included in the non-overlapping region NR is the ideal output value Aᵢ=A^{NonLap}. The color unevenness correction value S₁ of the grid point NP adjacent to the grid point DP among the grid points NP included in the non-overlapping region NR is the color unevenness correction value S₁=S₁^{NonLap}. The color unevenness correction value S₀ at the grid point DP included in the overlapping region DR is the above S₀=S₀^{Lap}. The brightness correction value C₀=C^{NonLap} of the grid point NP adjacent to the grid point DP is calculated by these values and Formula 6.

As illustrated in FIG. 25, at a stage where the sub-step SS4[3] is completed, the ideal output value Aᵢ and the color unevenness correction value S₁ are calculated at all the grid points DP and all the grid points NP. The color unevenness correction value S₀ and the brightness correction value C₀ are calculated at the grid point DP included in the overlapping region DR and at the grid point NP adjacent to the grid point DP among the grid points NP included in the non-overlapping region NR.

In sub-step SS4[4] of FIG. 18, the processing device 13 uniformly determines the brightness correction value C₀=C^{NonLap} in the entire non-overlapping region NR based on the brightness correction value C₀=C^{NonLap} of the grid point NP adjacent to the overlapping region DR across the boundary between the non-overlapping region NR and the overlapping region DR, which is calculated in sub-step SS4[3]. For example, the processing device 13 calculates an average value of the brightness correction values C₀=C^{NonLap} of the grid points NP adjacent to the overlapping region DR across the boundary between the non-overlapping region NR and region DR, which are calculated in sub-setp SS4[3], and sets the average value as the brightness correction value C₀=C^{NonLap} at all the grid points NP included in the non-overlapping region NR. As described above with reference to FIG. 19, this is because the brightness correction circuit LC sets the brightness correction value C₀ which is a uniform adjustment amount (offset amount) to each of the overlapping region DR and the non-overlapping region NR.

FIG. 26 is a diagram illustrating an example of how the color unevenness correction value S₀, the brightness correction value C₀, the ideal output value Aᵢ, and the color unevenness correction value S₁ are calculated in sub-step SS4[4]. The average value of the brightness correction values C₀=C^{NonLap} set at the grid points NP adjacent to the overlapping region DR across the boundary between the non-overlapping region NR and the overlapping region DR in FIG. 25 is set as the brightness correction value C₀=C^{NonLap} for all the grid points NP in FIG. 26.

As illustrated in FIG. 26, at a stage where the sub-step SS4[4] is completed, the brightness correction value C₀, the ideal output value Aᵢ, and the color unevenness correction value S₁ are calculated at all the grid points DP and all the grid points NP. The color unevenness correction value S₀ is calculated at the grid points DP included in the overlapping region DR and at the grid points NP adjacent to the grid points DP among the grid points NP included in the non-overlapping region NR.

In sub-step SS4[5] of FIG. 18, the processing device 13 calculates the color unevenness correction value S₀=S₀^{NonLap′} based on the brightness correction value C₀=C^{NonLap} calculated in sub-step SS4[4] at all the grid points NP of the non-overlapping region NR. The processing in sub-step SS4[5] is also performed at the grid points NP adjacent to the grid points DP included in the overlapping region DR across the boundary between the non-overlapping region NR and the overlapping region DR for which the brightness correction value C₀=C^{NonLap} is calculated in sub-step SS4[3]. This is because the brightness correction value C₀=C^{NonLap} at the grid point NP is changed through the processing in sub-step SS4[4].

The ideal output value Aᵢ=A^{NonLap}, the color unevenness correction value S₁=S₁^{NonLap} at the tone 146, and the brightness correction value C₀=C^{NonLap} are known, and when these values are substituted into Formula 2, Formula 7 is obtained. The color unevenness correction value S₀=S₀^{NonLap′} is calculated by transforming Formula 7 into Formula 8.

The color unevenness correction value S₀=S₀^{NonLap′} of the non-overlapping region NR is an example of a “second color unevenness correction value”.

$${A}^{NonLap} = \frac{{S}_{1}^{NonLap} - {S}_{0}^{NonLap ′}}{146 - 0} * {C}^{NonLap} + {S}_{0}^{NonLap} \qquad [ 7 ]$$

$${S}_{0}^{NonLap ′} = \frac{{S}_{1}^{NonLap} {C}^{NonLap} - 146 {A}^{NonLap}}{{C}^{NonLap} - 146} \qquad [ 8 ]$$

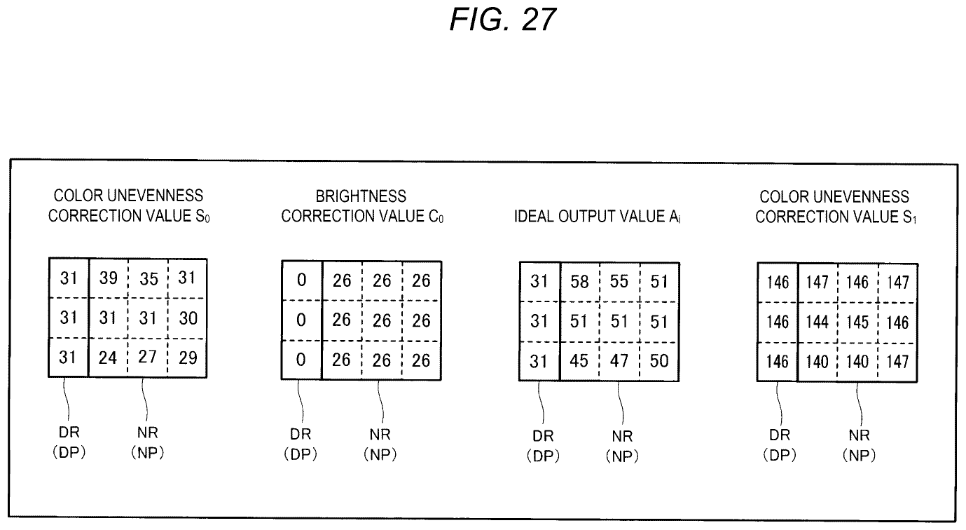

FIG. 27 is a diagram illustrating an example of how the color unevenness correction value S₀, the brightness correction value C₀, the ideal output value Aᵢ, and the color unevenness correction value S₁ are calculated in sub-step SS4[5].

In FIG. 27, the ideal output value Aᵢ of the grid point NP adjacent to the grid point DP among the grid points NP included in the non-overlapping region NR is the ideal output value Aᵢ=A^{NonLap}. The color unevenness correction value S₁ of the grid point NP adjacent to the grid point DP among the grid points NP included in the non-overlapping region NR is the color unevenness correction value S₁=S₁^{NonLap}. The brightness correction value C₀ at the grid point NP included in the non-overlapping region NR is C₀=C^{NonLap} described above. The color unevenness correction value S₀=S₀^{NonLap′} is calculated by these values and Formula 7.

As illustrated in FIG. 27, at a stage where the sub-step SS4[5] is completed, the color unevenness correction value S₀, the brightness correction value C₀, the ideal output value Aᵢ, and the color unevenness correction value S₁ are calculated at all the grid points DP and all the grid points NP.

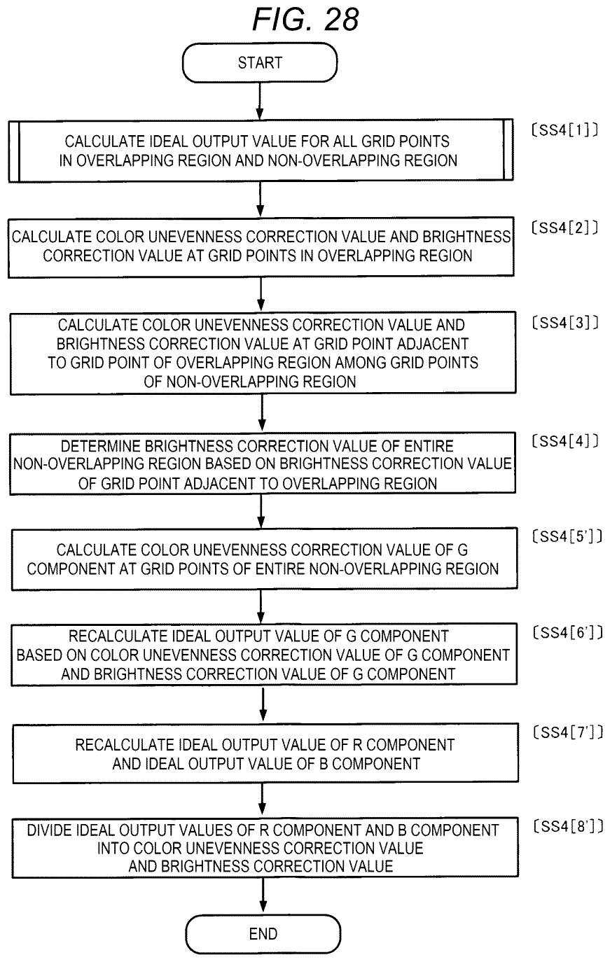

FIG. 28 is a flowchart illustrating sub-steps SS4[1] to SS4[8′] of step S4 when the second parameter indicates that priority is given to the flatness of brightness.

The flowchart illustrated in FIG. 28 is different from the flowchart illustrated in FIG. 18 in that the flowchart illustrated in FIG. 28 includes sub-step SS4[5′] instead of sub-step SS4[5], and further includes sub-steps SS4[6′] to SS4[8′]. Hereinafter, for the sake of simplicity of description, sub-steps SS4[5′] to SS4[8′] which are different from the flowchart illustrated in FIG. 28 will be described.

In sub-step SS4[5′] of FIG. 28, the processing device 13 calculates the color unevenness correction value S₀=S₀_G of the G component for all the grid points NP in the non-overlapping region NR.

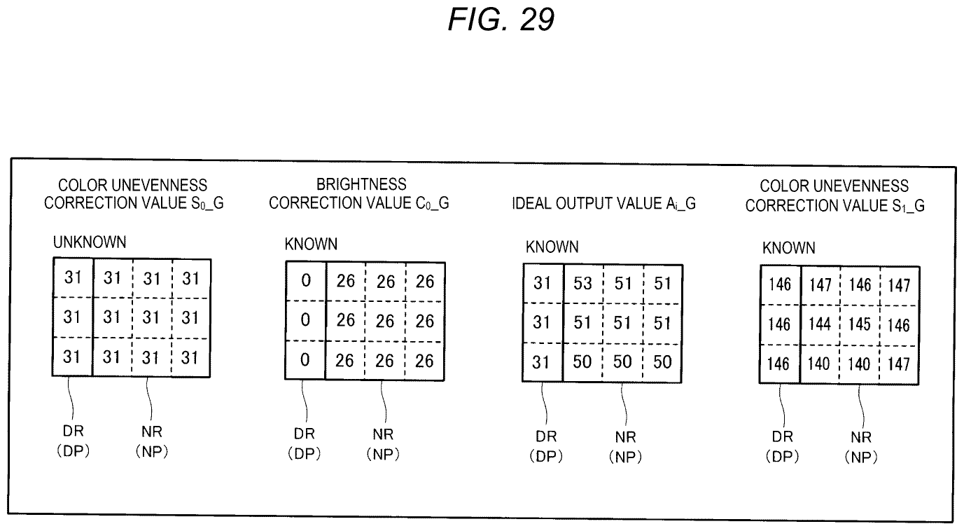

FIG. 29 is a diagram illustrating an example of how the color unevenness correction value S₀_G, the brightness correction value C₀, an ideal output value Aᵢ_G, and a color unevenness correction value S₁_G are calculated in the sub-step SS4[5′].

The processing device 13 first sets the color unevenness correction value S₀=S₀_G of the G component at the grid point NP adjacent to the grid point DP across the boundary between the overlapping region DR and the non-overlapping region NR to the same value as the color unevenness correction value S₀=S₀_G of the G component at the grid point DP. Thereafter, the processing device 13 applies the color unevenness correction value S₀=S₀_G of the G component set to the grid point NP adjacent to the grid point DP to all the grid points NP included in the non-overlapping region NR. As a result, in the example illustrated in FIG. 29, the color unevenness correction values S₀=S₀_G of the G component at all the grid points NP are the same as the color unevenness correction value S₀=S₀_G of the G component at the grid points DP included in the overlapping region DR. In sub-step SS4[5′], the color unevenness correction values S₀=S₀_G of the G component of all the grid points LP are determined. The color unevenness correction value S₀=S₀_G of the G component at the grid point NP adjacent to the grid point DP may be an average value of the color unevenness correction values S₀=S₀_G of a plurality of grid points DP to be processed.

As illustrated in FIG. 29, at a stage where the sub-step SS4[5′] is completed, the color unevenness correction value S₀ G, the brightness correction value C₀_G, the ideal output value Aᵢ_G, and the color unevenness correction value S₁_G are calculated at all the grid points DP and all the grid points NP.

In sub-step SS4[5′], the processing device 13 discards the color unevenness correction value S₀=S₀_R of the R component and the color unevenness correction value S₀=S₀_B of the B component. This is because, as a feature of human vision, a contour of an image viewed from a human eye is determined substantially due to the G component among the R component, the G component, and the B component.

In sub-step SS4[6′] in FIG. 28, the processing device 13 recalculates the ideal output value Aᵢ_G of the G component based on the color unevenness correction value S₀=S₀_G of the G component and the brightness correction value C₀=C₀_G of the G component.

Specifically, the processing device 13 calculates the ideal output value Aᵢ_G of the G component by the following Formula 9 in which the color unevenness correction value S₀=S₀_G of the G component, the brightness correction value C₀=C₀_G of the G component, and the color unevenness correction value S₁=S₁_G of the G component are substituted into Formula 2.

$${A}_{i} \_G = \frac{{S}_{1} \_G - {S}_{0} \_G}{146 - 0} * {C}_{0} \_G + {S}_{0} \_G \qquad [ 9 ]$$

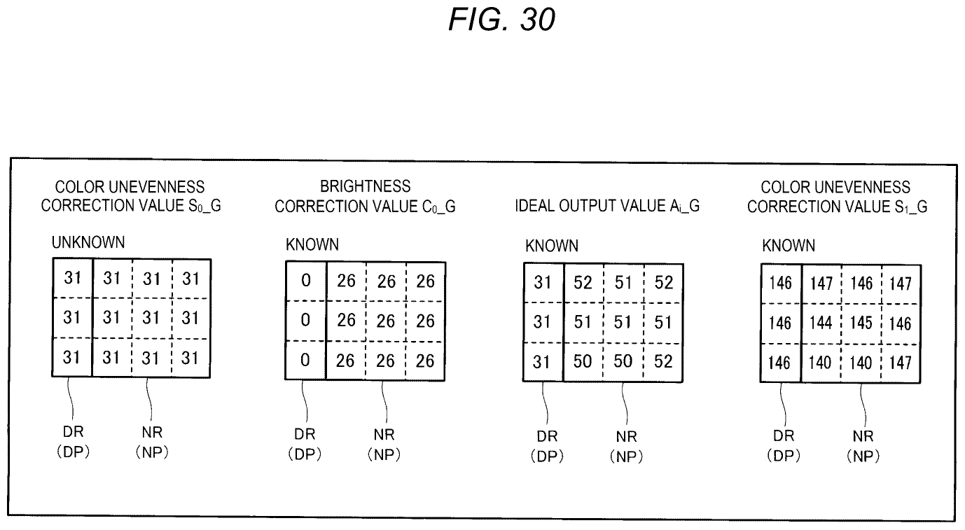

FIG. 30 is a diagram illustrating an example of how the color unevenness correction value S₀_G, the brightness correction value C₀_G, the ideal output value Aᵢ_G, and the color unevenness correction value S₁_G are calculated in the sub-step SS4[6′]. In FIG. 30, the ideal output value Aᵢ_G changes from an initial value, and corrected brightness in the overlapping region DR and corrected brightness in the non-overlapping region NR are different from each other.

As illustrated in FIG. 30, at a stage where the sub-step SS4[5′] is completed, the color unevenness correction value S₀_G, the brightness correction value C₀_G, the ideal output value Aᵢ_G, and the color unevenness correction value S₁_G are calculated at all the grid points DP and all the grid points NP.

In sub-step SS4[7′] of FIG. 28, the processing device 13 recalculates the ideal output value Aᵢ_R of the R component and the ideal output value Aᵢ_B of the B component.

Specifically, the processing device 13 recalculates the ideal output value Aᵢ_R and the ideal output value Aᵢ_B after fixing the ideal output value Aᵢ_G to the value calculated in sub-step SS4[6′] for the Yu′v′ values or the RGB values which are the ideal output values Aᵢ that have already been calculated.

In sub-step SS4[8′] of FIG. 28, the processing device 13 divides the ideal output value Aᵢ_R into the color unevenness correction value S₀_R and the brightness correction value C₀_R by performing the same processing as in sub-step SS4[3] to sub-step SS4[5] illustrated in FIG. 18 on the ideal output value Aᵢ_R calculated in sub-step SS4[7′]. The processing device 13 divides the ideal output value Aᵢ_B into the color unevenness correction value S₀_B and the brightness correction value C₀_B by the same method.

In step S5 of FIG. 4, the processing device 13 selects one set of correction values from a plurality of sets of correction values calculated in step S4.

For example, the processing device 13 selects one set of correction values based on information corresponding to an input to the information processing apparatus 20 from a user. For example, the information is first information indicating whether to give priority to the contrast ratio or give priority to the accuracy of correction of color unevenness of black in the projection image PI_A. In this case, the information corresponds to the first parameter described above.

Further, for example, the information corresponding to the input to the information processing apparatus 20 from the user is second information indicating whether to give priority to the uniformity of brightness between the overlapping region DR and the non-overlapping region NR or give priority to the flatness of brightness in each of the overlapping region DR and the non-overlapping region NR in the projection image PI_A. In this case, the information corresponds to the second parameter. The information corresponding to the input to the information processing apparatus 20 from the user may include both the first information and the second information.

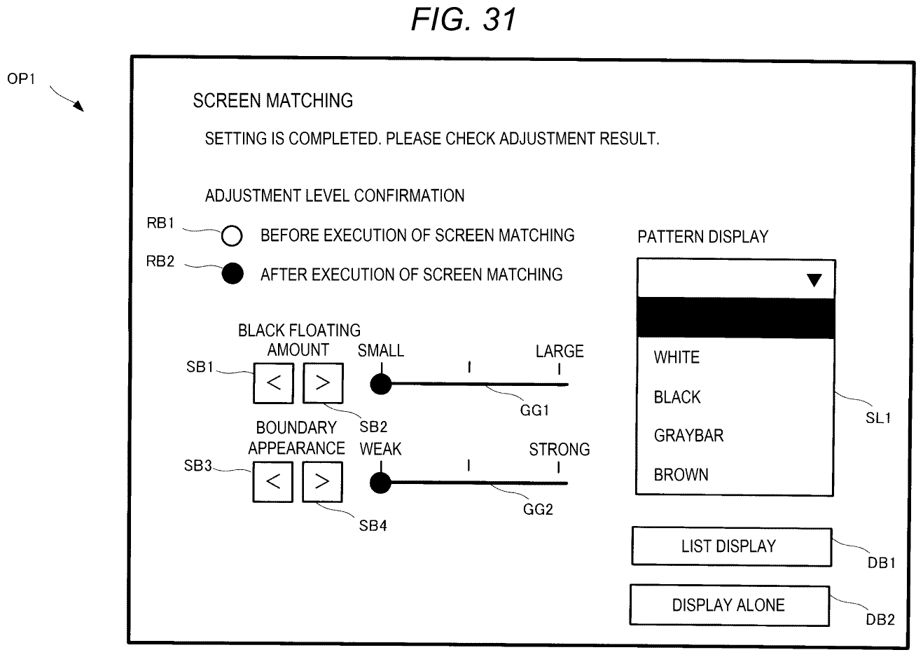

FIG. 31 is a diagram illustrating an example of an operation screen OP1 displayed on a display device (not illustrated) provided in the information processing apparatus 20 or communicably connected to the information processing apparatus 20. For example, a touch panel which is an input device is superimposed on the display device.

The operation screen OP1 includes a radio button RB1, a radio button RB2, selection buttons SB1 to SB4, a first gauge GG1, a second gauge GG2, a selection list SL1, a display button DB1, and a display button DB2. A user operates these operators by touching or clicking using a touch panel or a mouse. Hereinafter, touching or clicking may be expressed as an operation.

The radio button RB1 and the radio button RB2 are buttons for selecting whether to display a preview image of the projection image PI before correction or display a preview image of the projection image PI after correction. When the user touches the display button DB2 or clicks the display button DB2 in a state in which the radio button RB1 is selected, the preview image PR of the projection image PI before correction is displayed on the projection surface SC. On the other hand, when the user operates the display button DB1 in the state in which the radio button RB2 is selected, the preview images PR of the above-described nine projection images PI after correction are displayed as a list on the projection surface SC. Further, when the user operates the display button DB2 in the state in which the radio button RB2 is selected, the preview image PR of the projection image PI after correction by a correction method selected by the selection buttons SB1 to SB4 is displayed alone on the projection surface SC. When the radio button RB1 is selected, the display button DB2 may be disabled, and the preview image PR of the projection image PI before correction may be displayed alone on the projection surface SC by operating either the display button DB1 or the display button DB2.

When the display button DB1 or the display button DB2 is operated, the processing device 13 acquires information for selecting which one of the projection image PI_A before correction and the projection image PI_A after correction is to be displayed on the projection surface SC according to a selection result of the radio button RB1 and the radio button RB2. The information indicating the selection result of the radio button RB1 and the radio button RB2 is an example of “fifth information”.

The selection button SB1 and the selection button SB2 are buttons for selecting an amount of “black floating” in the projection image PI. When the user operates the selection button SB1, an identifier moves to the left on the first gauge GG1. When the user operates the selection button SB2, the identifier moves to the right on the first gauge GG1. The amount of “black floating” decreases as the identifier moves to the left on the first gauge GG1. The amount of “black floating” increases as the identifier moves to the right on the first gauge GG1. In the embodiment, the identifier can take three positions of both ends and the center of the first gauge GG1. The selection result of the selection button SB1 and the selection button SB2 corresponds to the first parameter described above.

One set of correction values among the plurality of sets of correction values for correcting the projection image PI_A is selected based on the selection result of the selection button SB1 and the selection button SB2. The correction value is an example of “correction information”.

As described above, the processing device 13 determines the brightness of black of the projection image PI1 in the overlapping region DR based on the first information.

The selection button SB3 and the selection button SB4 are buttons for selecting a level at which the boundary between the overlapping region DR and the non-overlapping region NR in the projection image PI is noticed. When the user operates the selection button SB3, an identifier moves to the left on the second gauge GG2. When the user operates the selection button SB4, the identifier moves to the right on the second gauge GG2. On the second gauge GG2, the level of contour enhancement decreases when the identifier moves to the left, and as a result, the boundary between the overlapping region DR and the non-overlapping region NR is less noticeable. On the second gauge GG2, the level of contour enhancement increases when the identifier moves to the right, and as a result, the boundary between the overlapping region DR and the non-overlapping region NR is noticeable. In the embodiment, the identifier can take three positions of both ends and the center of the second gauge GG2. The selection result of the selection button SB3 and the selection button SB4 corresponds to the second parameter described above.

One set of correction values among the plurality of sets of correction values for correcting the projection image PI_A is selected based on the selection result of the selection button SB3 and the selection button SB4. The correction value is an example of “correction information”.

As described above, based on the first information and the second information, the processing device 13 performs correction to reduce a brightness difference of black between the overlapping region DR and the non-overlapping region NR and reduce color unevenness in the projection image PI_A.

As described above, when the user selects an amount of “black floating” by the selection button SB1 and the selection button SB2, selects a level at which the boundary between the overlapping region DR and the non-overlapping region NR is noticed by the selection button SB3 and the selection button SB4, and then operates the display button DB2, the first information and the second information are transmitted from the information processing apparatus 20 to the projecting apparatus 10A. The processing device 13 acquires the first information and the second information. The processing device 13 creates the preview image PR of the projection image PI corresponding to the first information and the second information, and outputs the preview image PR to the projector 11 and the information processing apparatus 20. As a result, the preview image PR of the projection image PI corrected by the correction method selected by the selection buttons SB1 to SB4 is displayed alone on the display device and the projection surface SC described above.

The selection list SL1 is a list for selecting a pattern image to be projected by the projecting apparatus 10. The selection list SL1 includes a white pattern, a black pattern, a gray bar, and a brown pattern. Here, the white pattern is a pattern for correcting color unevenness of a color on a high tone side. The black pattern is a black image as a whole, and is an image for performing the above correction. When nothing is selected in the selection list SL1, an image or a black pattern supplied to the projecting apparatus 10A by the information processing apparatus 20 as an image supply device is projected. A plurality of pattern images illustrated in the selection list SL1 are a plurality of candidates for the projection image PI_A. The information processing apparatus 20 receives a user operation of selecting one pattern image from the selection list SL1. Information indicating the one pattern image is an example of “fourth information”. The processing device 13 acquires the fourth information from the information processing apparatus 20. The processing device 13 creates the preview image PR using the pattern image indicated by the fourth information.

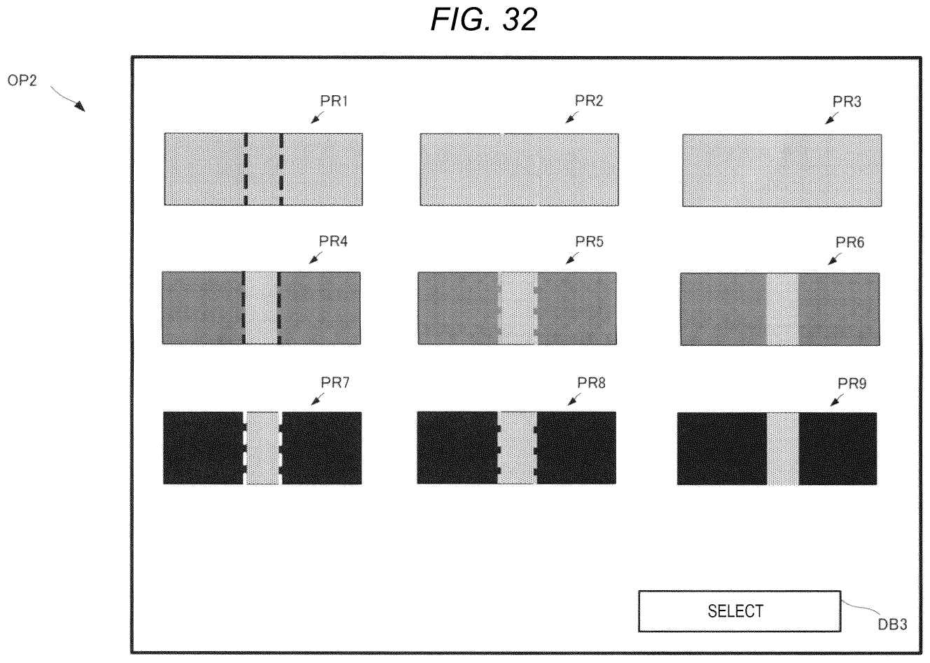

FIG. 32 is a diagram illustrating an example of an operation screen OP2 displayed on the display device when the user operates the display button DB1 on the operation screen OP1 illustrated in FIG. 31. Preview images PR1 to PR9 displayed in a list on the projection surface SC are displayed in a list on the operation screen OP2. The operation screen OP2 includes a selection button DB3. The preview images PR1 to PR9 are displayed in a list on the projection surface SC in the same arrangement as that in FIG. 32. When the preview images PR1 to PR9 are displayed in a list, the preview images PR1 to PR9 may be created using one pattern image selected from the selection list SL1. Since it is sufficient that a user can recognize a difference in appearance among the images, a schematic diagram simply representing the difference among the preview images PR1 to PR9 may be used.

In FIG. 32, when the preview image PR1 to the preview image PR3 are compared, the boundary between the overlapping region DR and the non-overlapping region NR is the most noticeable in the preview image PR1, and the boundary between the overlapping region DR and the non-overlapping region NR is the least noticeable in the preview image PR3. A level at which the boundary between the overlapping region DR and the non-overlapping region NR is noticed in the preview image PR2 is intermediate between the preview image PR1 and the preview image PR3.

When the preview images PR4 to PR6 are compared, the boundary between the overlapping region DR and the non-overlapping region NR is the most noticeable in the preview image PR4, and the boundary between the overlapping region DR and the non-overlapping region NR is the least noticeable in the preview image PR6. A level at which the boundary between the overlapping region DR and the non-overlapping region NR is noticeable in the preview image PR5 is intermediate between the preview image PR4 and the preview image PR6.

When the preview images PR7 to PR9 are compared, the boundary between the overlapping region DR and the non-overlapping region NR is the most noticeable in the preview image PR7, and the boundary between the overlapping region DR and the non-overlapping region NR is the least noticeable in the preview image PR9. A level at which the boundary between the overlapping region DR and the non-overlapping region NR is noticeable in the preview image PR8 is intermediate between the preview image PR7 and the preview image PR9.

In FIG. 32, when the preview image PR1, the preview image PR4, and the preview image PR7 are compared, an amount of “black floating” in the preview image PR1 is the smallest, and an amount of “black floating” in the preview image PR7 is the largest. An amount of “black floating” in the preview image PR4 is an intermediate amount between the preview image PR1 and the preview image PR7.

When the preview image PR2, the preview image PR5, and the preview image PR8 are compared, an amount of “black floating” in the preview image PR2 is the smallest, and an amount of “black floating” in the preview image PR8 is the largest. An amount of “black floating” in the preview image PR5 is an intermediate amount between the preview image PR2 and the preview image PR8.

When the preview image PR3, the preview image PR6, and the preview image PR9 are compared, an amount of “black floating” in the preview image PR3 is the smallest, and an amount of “black floating” in the preview image PR9 is the largest. An amount of “black floating” in the preview image PR6 is an intermediate amount between the preview image PR3 and the preview image PR9.

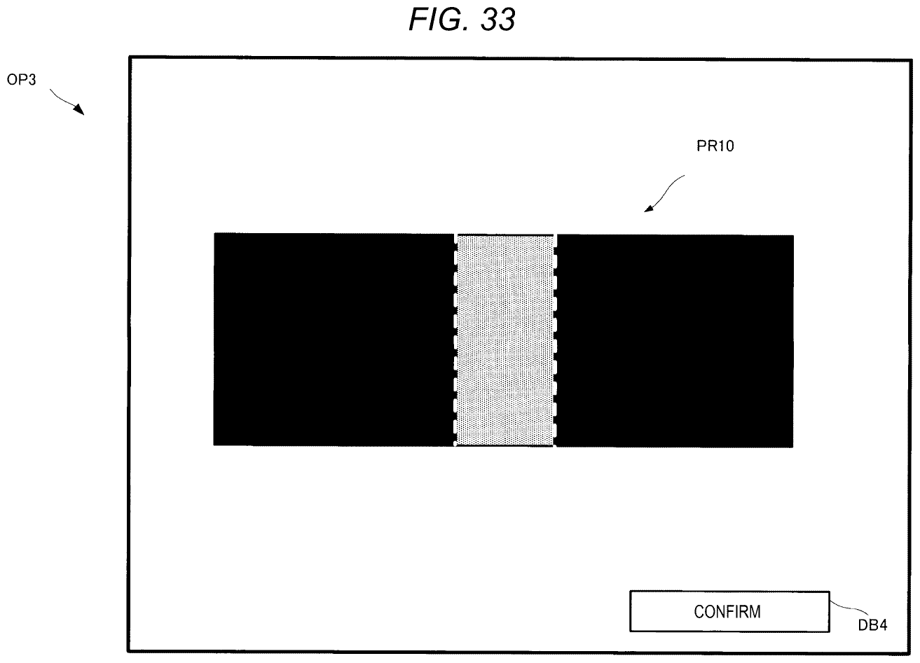

The user selects one preview image PR from the preview image PR1 to the preview image PR9 on the operation screen OP2, and touches the selection button DB3 or clicks the selection button DB3. Then, as illustrated in FIG. 33 to be described later, the selected preview image PR is displayed alone.

When the user operates the selection button DB3, the processing device 13 acquires information for selecting one preview image PR from the preview image PR1 to the preview image PR9. The information is an example of “sixth information”.

FIG. 33 is a diagram illustrating an example of an operation screen OP3 displayed on the display device when the user operates the display button DB2 in a state where the radio button RB2 is selected on the operation screen OP1 illustrated in FIG. 31. A preview image PR10 of the projection image PI corrected as a selection result of the selection buttons SB1 to SB4 on the operation screen OP1 is displayed alone on the operation screen OP3. The operation screen OP3 includes a confirm button DB4. The preview image PR10 is also displayed alone on the projection surface SC.

The user operates the confirm button DB4 in a state where the preview image PR10 is displayed. As a result of the operation, a correction method indicated by the preview image PR10 is determined. In this case, the processing device 13 acquires the information indicating that the confirm button DB4 is operated as the information for confirming the first information and the second information as setting information when the projection image PI_A is displayed. The information is an example of “third information”. As a result, in step S5 of FIG. 4, the brightness correction value C₀ and the color unevenness correction value S₀ corresponding to the correction method are selected. The preview image PR10 displayed when the radio button RB2 is selected is the corrected projection image PI. By displaying the corrected projection image PI before acquiring the third information, the user can confirm a correction method after confirming a correction result.

As described above, when the user operates the display button DB2 on the operation screen OP1 illustrated in FIG. 31, the operation screen OP3 illustrated in FIG. 33 is displayed.

When the preview image PR1 to the preview image PR10 illustrated in FIGS. 32 and 33 are projected on the projection surface SC, it is preferable that images different from the preview image PR1 to the preview image PR10, for example, on screen display (OSD) images of the projecting apparatuses 10A to 10C are not superimposed on the preview image PR1 to the preview image PR10 on the projection surface SC. The OSD images are images created by the projecting apparatus 10A to the projecting apparatus 10C.

In this case, for example, a control signal instructing not to superimpose the OSD images on the preview image PR1 to the preview image PR10 is transmitted from the information processing apparatus 20 to the projecting apparatuses 10A to 10C. Further, in the information processing apparatus 20, it is preferable that the control signal is transmitted from the information processing apparatus 20 to the projecting apparatuses 10A to 10C with the display of the operation screen OP1 as a trigger. Alternatively, a control signal instructing not to issue any notification to the projection surface SC may be transmitted from the information processing apparatus 20 to the projecting apparatuses 10A to 10C.

When the OSD images are displayed on the projection surface SC, it is preferable that the OSD images are displayed darker than the preview image PR1 to the preview image PR10. More specifically, for example, it is preferable that an average value of luminance of all the OSD images is lower than an average value of luminance of all the preview images PR1 to PR10.

When the projecting apparatuses 10A to 10C display the preview image PR on the projection surface SC, it is preferable to display the preview image PR with a size and a shape of the projection image PI_A. The user can more accurately recognize the appearance of the projection image PI_A than in a case where the preview image PR with a size smaller than a size of the projection image PI_A is displayed. When the small preview image PR is displayed, it is preferable that luminance of a region other than the preview image PR of the projection image PI_A is lower than luminance of the preview image PR, and it is more preferable that the luminance is 0.

In step S6 in FIG. 4, the processing device 13 provided in the projecting apparatus 10A functions as the correction value calculator 134. The processing device 13 sets the brightness correction value C₀ selected in step S5 in the brightness correction circuit LC and sets the color unevenness correction value S₀ in the color unevenness correction circuit UC.

In FIG. 2, when a tone value of each pixel of an image acquired by the image acquisition unit 135 is input, the brightness correction circuit LC calculates a tone value to be output to the color unevenness correction circuit UC using the brightness correction value C₀. When the tone value calculated by the brightness correction circuit LC is input, the color unevenness correction circuit UC outputs the output value Aᵤ of the color unevenness correction circuit UC based on the color unevenness correction value S₀. The output value Aᵤ is a tone value and is input to the projection controller 131. The projection controller 131 converts the output value Aᵤ into a control signal for driving a liquid crystal panel and outputs the control signal to the projector 11. As a result, the projection image PI in which the black color unevenness and the “black floating” are corrected is projected from the projector 11 onto the projection surface SC.

In the above embodiment, a set of a plurality of types of correction values is calculated only for black correction values.

### 1-3: Supplement (Ideal Output Value Calculation Method)

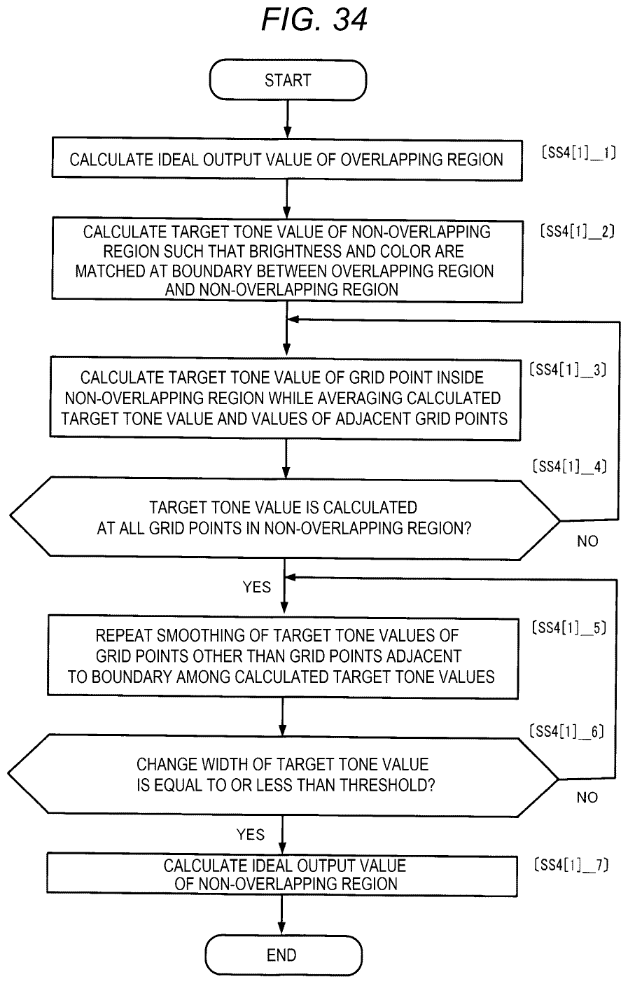

FIG. 34 is a flowchart illustrating sub-steps SS4[1]_1 to SS4[1]_7 of sub-step SS4[1]. In the flowchart illustrated in FIG. 34, the processing device 13 first calculates the ideal output value Aᵢ of the overlapping region DR, and then calculates target values of brightness and chromaticity of the non-overlapping region NR. Thereafter, the processing device 13 calculates the ideal output value Aᵢ in the non-overlapping region NR based on the calculated target values.

For the sake of simplicity, only a method of calculating the ideal output value Aᵢ at the grid points LP included in the projection image PI2 will be described below. A method of calculating the ideal output value Aᵢ at the grid points LP included in the projection image PI1 and the projection image PI3 is basically the same.

In sub-step SS4[1]_1, the processing device 13 calculates the ideal output value Aᵢ at the grid points DP included in the overlapping region DR on the assumption that the target brightness and chromaticity in the overlapping region DR have already been determined by a known method. The processing device 13 may use a known method as a method of calculating the ideal output value Aᵢ.

Specifically, the processing device 13 determines a target tone value of the overlapping region DR in advance. The processing device 13 calculates a brightness component Y as a target value based on the determined tone value for each grid point DP in the overlapping region DR illustrated in FIGS. 5 to 7. The “brightness component Y as a target value” is the brightness component Y as the target value for correcting the “black floating” described above.

The processing device 13 calculates the brightness component Y as a target value for each grid point DP. Specifically, even when luminance unevenness originally exists in the overlapping region DR, the processing device 13 does not uniformly adjust the luminance unevenness in the overlapping region DR, but calculates the brightness component Y as a target value for each grid point DP. When the processing device 13 uniformly adjusts the luminance unevenness, it is necessary to reduce the luminance at each grid point DP, and in this case, the number of steps of a tone that can be corrected at each grid point DP is reduced. The reason why the processing device 13 determines the brightness component Y as a target value for each grid point DP in advance is to ensure a minimum correction amount that can remove color unevenness as described above uniformly at all grid points DP.

The processing device 13 determines a chromaticity component u′v′ as a chromaticity target value of the overlapping region DR in advance. The “chromaticity component u′v′ as a target value” is a chromaticity component u′v′ as a target value for correcting the color unevenness. The processing device 13 determines the chromaticity component u′v′ as the same target value in all the overlapping regions DR based on average chromaticity among the three projecting apparatuses 10 of the projecting apparatus 10A, the projecting apparatus 10B, and the projecting apparatus 10C, average chromaticity in each of the projecting apparatuses 10, a chromaticity design value at the time of product shipment of each of the projecting apparatuses 10, and the like. In this case, after the correction, all the overlapping regions DR have the same chromaticity.

Alternatively, the processing device 13 determines the chromaticity component u′v′ as the same target value in the overlapping regions DR based on the parameters described above. In this case, after the correction, the chromaticity is the same in the overlapping regions DR.

As a result, color unevenness in the overlapping region DR is corrected.

The processing device 13 converts the Yu′v′ value as the target value including the brightness component Y as the target value and the chromaticity component u′v′ as the target value at each grid point DP in the overlapping region DR into the RGB values. Further, the processing device 13 back-calculates the converted RGB values to the target tone values (r, g, b) to be output from the corrector 136 to the projector 11. The processing device 13 sets the target tone value as the ideal output value Aᵢ to be output from the corrector 136 to the projector 11. That is, in this regard, the ideal output value Aᵢ indicates the target tone values (r, g, b).

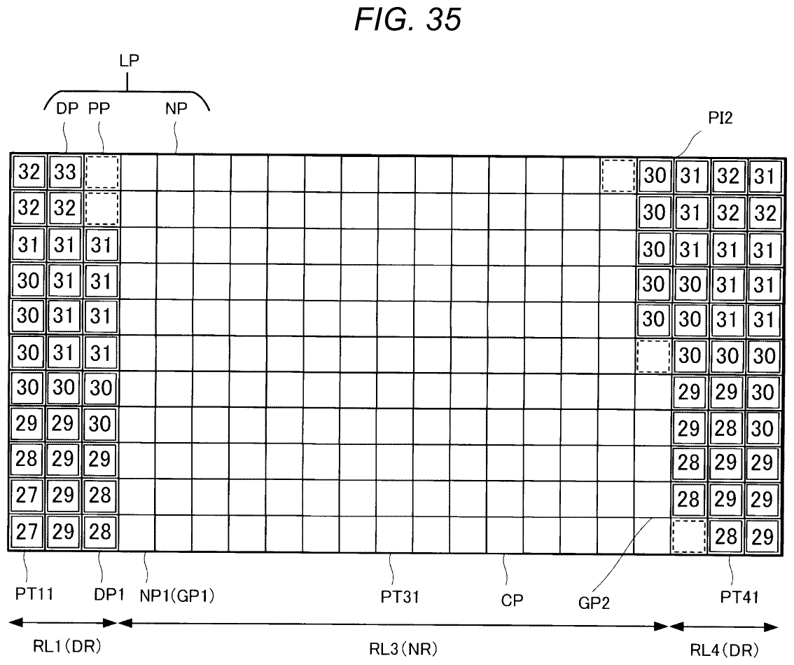

FIG. 35 is a diagram illustrating an example of the target tone values (r, g, b) at the grid point DP calculated by the processing device 13. FIG. 35 is a diagram illustrating an example of a value of one component among the r component, the g component, and the b component included in the tone values (r, g, b). FIG. 35 corresponds to the projection image PI2 illustrated in FIG. 6.

Further, each rectangle illustrated in FIG. 35 indicates each part PT of the projection image PI including the grid points LP illustrated in FIG. 6. A region RL1 includes a plurality of parts PT11. A region RL3 includes a plurality of parts PT31. A region RL4 includes a plurality of parts PT41.

A numerical value described inside the rectangle is a value of one component among the r component, the g component, and the b component included in the target tone values (r, g, b).

In order to simplify the description, each numerical value is indicated by an integer in FIG. 35, but may be a decimal number in practice. The same applies to numerical values illustrated below.

Among the rectangles illustrated in FIG. 35, a rectangle whose frame line is a double line corresponds to the grid point DP. As described above, the grid point DP is the grid point LP included in the overlapping region DR. A rectangle whose frame line is a single line corresponds to the grid point NP. As described above, the grid point NP is the grid point LP included in the non-overlapping region NR. A rectangle whose frame line is a double line and one line is a dotted line corresponds to the grid point PP. As described above, the grid point PP is the grid point LP for which it cannot be determined whether the grid point PP belongs to the overlapping region DR or the non-overlapping region NR.

In sub-step SS4[1]_2 of FIG. 34, the processing device 13 determines the target tone values (r, g, b) at the grid point NP so that brightness and a color are matched between the grid point DP belonging to the overlapping region DR and the grid point NP belonging to the non-overlapping region NR, which are adjacent to each other across the boundary between the overlapping region DR and the non-overlapping region NR.

The target tone values (r, g, b) at the grid point NP are calculated based on the target tone values (r, g, b) at the grid point DP. Hereinafter, a specific calculation method will be described.

In FIG. 35, a grid point DP1 is an example of the grid point DP. A grid point NP1 is an example of the grid point NP. The grid point DP1 and the grid point NP1 are adjacent to each other across the boundary between the overlapping region DR and the non-overlapping region NR.

In FIG. 35, the tone values (r, g, b) of the grid point DP1 have already been calculated. The processing device 13 estimates RGB values as a measurement value by the imaging device 12 based on the tone values (r, g, b). The processing device 13 converts the estimated RGB values which are the measurement value into XYZ values. Further, the processing device 13 further converts the converted XYZ values into the Yu′v′ values by applying the above Formula 1 to the converted XYZ values.

Accordingly, since the Yu′v′ value of the grid point DP1 is calculated, the processing device 13 sets the Yu′v′ value as a Yu′v′ value, which is a target value, of the grid point NP1. Further, the processing device 13 calculates tone values (r, g, b), which are a target value, of the grid point NP1 based on the Yu′v′ value which is a target value.

In FIG. 35, the region RL3 includes a plurality of intermediate parts CP between a first adjacent part GP1 and a second adjacent part GP2.

In the following, in order to simplify the description, a target value of brightness among target values of the grid point NP1 will be described. Since a calculation method for the target value of chromaticity is the same as the calculation method for the target value of brightness, description related to the target value of brightness is also applied to the target value of chromaticity.

When the brightness of the grid point NP1 is set as a target value, the processing device 13 calculates the tone value t such that the r component, the g component, and the b component satisfy (r, g, b)=(t, t, t) as the target tone values (r, g, b) of the grid point NP. Specifically, the processing device 13 calculates the tone value t such that the grid point DP1 and the grid point NP1 have the same brightness when the projector 11 projects gray light.

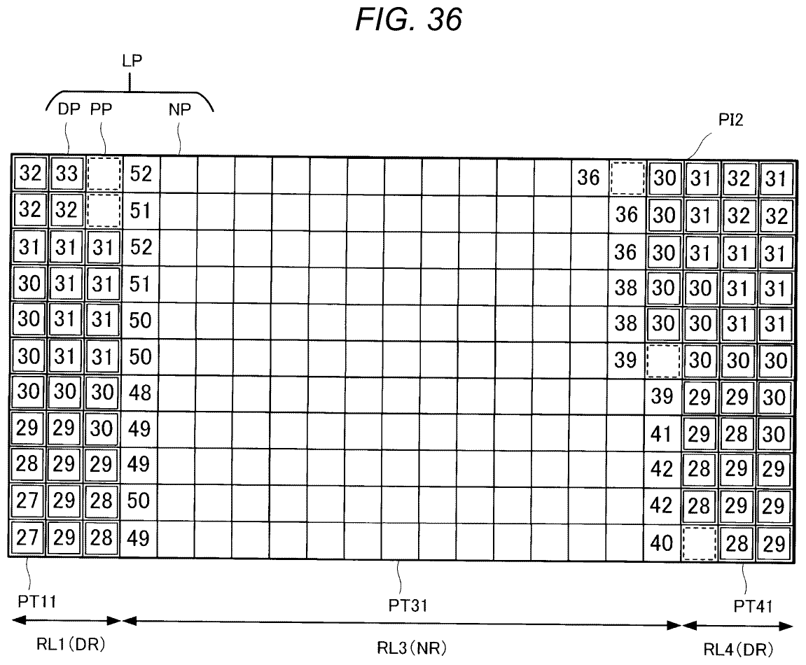

FIG. 36 is a diagram illustrating an example of the target tone values (r, g, b) at the grid point DP and the target tone value t at the grid point NP adjacent to the boundary between the overlapping region DR and the non-overlapping region NR.

In addition, when correction is not performed, since the non-overlapping region NR is darker than the overlapping region DR, in order to make the brightness component Y the same in the overlapping region DR and the non-overlapping region NR after correction, it is necessary to increase the target tone value t at the grid point NP to be larger than the target tone values (r, g, b) at the grid point DP.

In sub-step SS4[1]_3 of FIG. 34, the processing device 13 averages the target tone value t of the grid point NP calculated in sub-step SS4[1]_2 with the target tone value t of the adjacent grid point NP, thereby calculating the tone value t as a target value for more grid points NP.

Specifically, for the grid point NP for which the target tone value t is not determined, when there are one or more grid points NP for which the target tone value t is determined among the grid points NP adjacent in the vertical and horizontal directions, the processing device 13 calculates an average value of the target tone values t of these grid points NP. The processing device 13 sets the calculated average value as the target tone value t of the grid point NP for which the target tone value t is not determined.

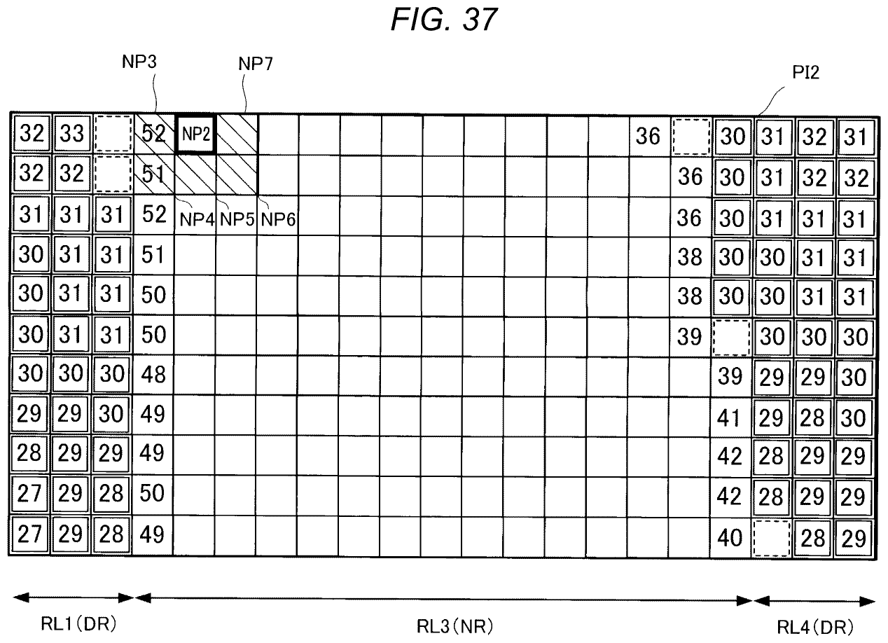

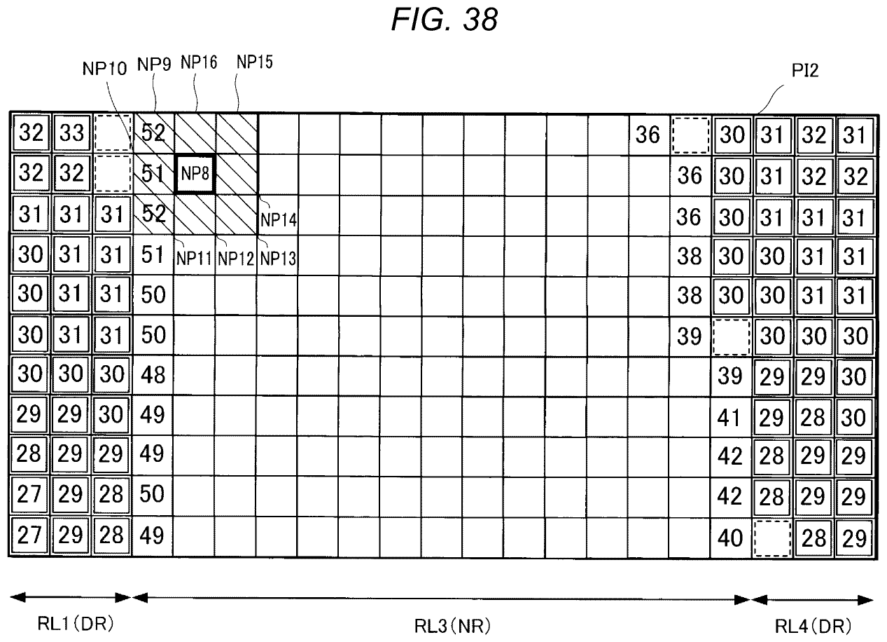

FIGS. 37 and 38 are diagrams illustrating an example of a method of determining the tone value t as the target value of the grid point NP for which the tone value t as the target value is not determined.

In FIG. 37, the grid point NP2 for which the target tone value t is not determined is located at an end of the non-overlapping region NR. In this case, as the grid points NP adjacent to the grid point NP2, there are five grid points NP from a grid point NP3 to a grid point NP7. Among these grid points NP3 to NP7, the target tone value t=52 is set for the grid point NP3. The target tone value t=51 is set for the grid point NP4. On the other hand, the tone value t as the target value is not set for the grid points NP5 to NP7. Therefore, the processing device 13 sets an average value of the target tone value t=52 of the grid point NP3 and the target tone value t=51 of the grid point NP4 as the target tone value t of the grid point NP2.

In FIG. 38, a grid point NP8 for which the target tone value t is not determined is located inside the non-overlapping region NR. In this case, as the grid points NP adjacent to the grid point NP8, there are eight grid points NP from a grid point NP9 to a grid point NP16. Among these eight grid points NP, the target tone value t=52 is set for the grid point NP9. The target tone value t=51 is set for the grid point NP10. The target tone value t=52 is set for the grid point NP11. On the other hand, the target tone value t is not set for the grid points NP12 to NP16. Therefore, the processing device 13 sets an average value of the target tone value t=52 of the grid point NP9, the target tone value t=51 of the grid point NP10, and the tone value t=52 as the target value of the grid point NP11 as the target tone value t of the grid point NP8.

In sub-step SS4[1]_4 of FIG. 34, the processing device 13 determines whether the target tone value t is calculated for all the grid points NP included in the non-overlapping region NR. When the target tone value t is calculated for all the grid points NP in the non-overlapping region NR (“YES” in sub-step SS4[1]_4), the processing device 13 executes processing of sub-step SS4[1]_5. On the other hand, when the target tone value t is not calculated for all the grid points NP in the non-overlapping region NR (“NO” in sub-step SS4[1]_4), the processing device 13 executes processing of sub-step SS4[1]_3.

As a result, the processing device 13 sequentially extends the grid point NP for which the target tone value t is to be calculated to the inside of the non-overlapping region NR.

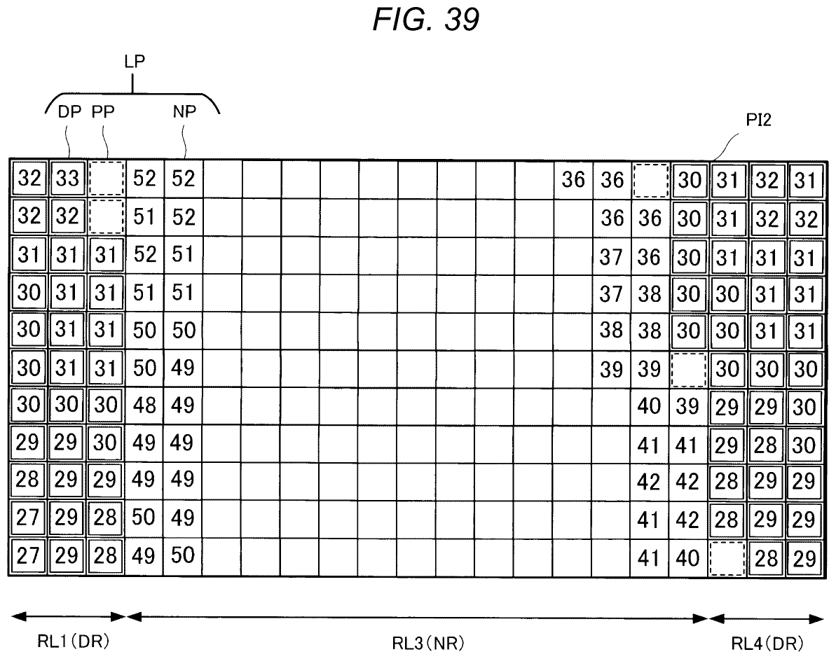

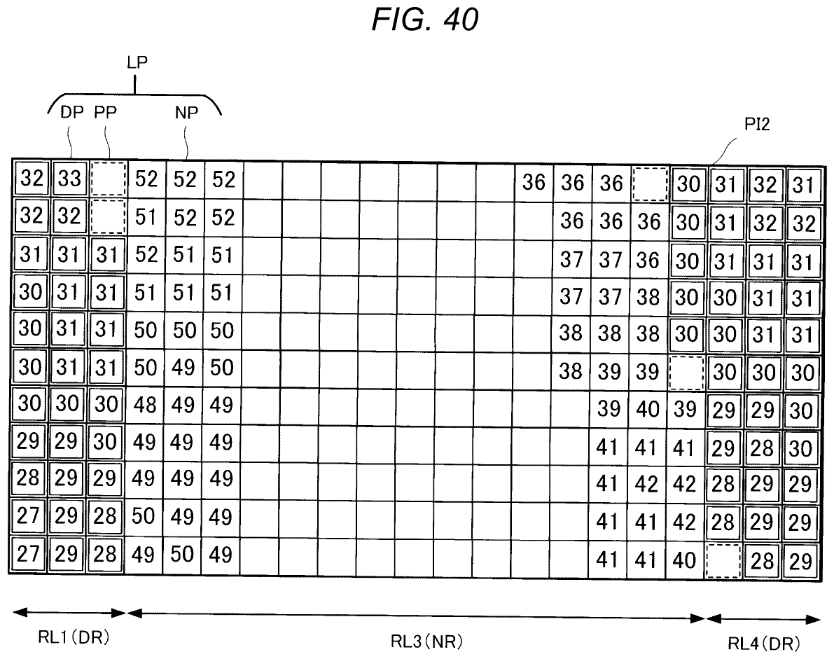

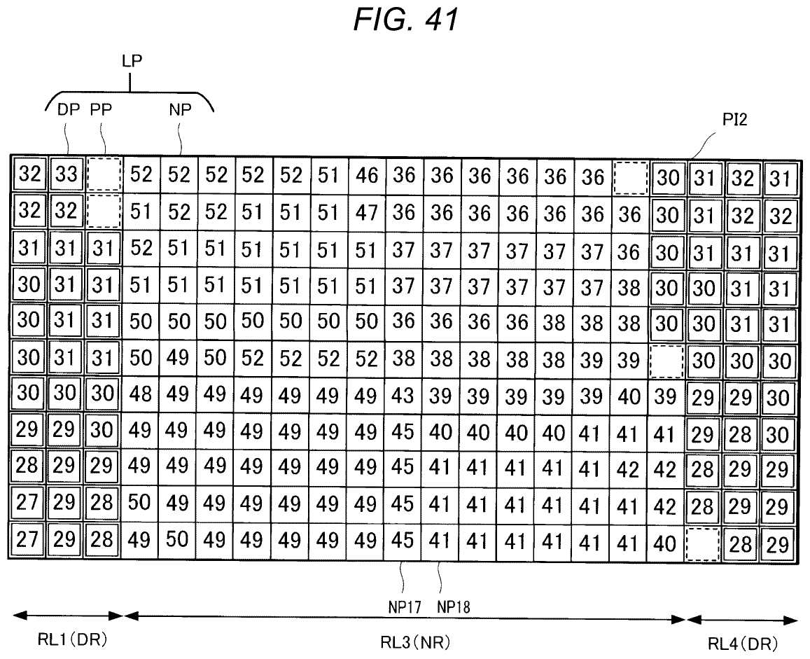

FIGS. 39 to 41 are diagrams illustrating an example of how the target tone value t is calculated. More specifically, FIG. 39 is a diagram illustrating how to calculate the target tone value t of the grid point NP adjacent to the inner side of the non-overlapping region NR with respect to the grid point NP adjacent to the boundary between the overlapping region DR and the non-overlapping region NR in an inner direction of the non-overlapping region NR, as compared with FIG. 38. FIG. 40 is a diagram illustrating how to calculate the target tone value t of the grid point NP adjacent to the inner side of the non-overlapping region NR with respect to the grid point NP for which the target tone value t is newly calculated in FIG. 39. FIG. 41 is a diagram illustrating how to calculate the target tone values t of all the grid points NP.

In sub-step SS4[1]_5 of FIG. 34, the processing device 13 repeats smoothing of the target tone value t of the grid point NP other than the grid point NP adjacent to the boundary between the overlapping region DR and the non-overlapping region NR among the calculated target tone values t. Specifically, the processing device 13 smooths the grid point NP other than the grid point NP adjacent to the boundary using the target tone value t of the effective grid point NP among the grid points NP adjacent to one another in the vertical and horizontal directions.

As illustrated in FIG. 41, when calculating the target tone value t of the grid point NP, the processing device 13 sequentially calculates the target tone values t of the grid points NP inside the non-overlapping region NR, that is, adjacent grid points NP in the right direction from the region RL1 which is the first overlapping region DR as described above. In parallel with this, the processing device 13 sequentially calculates the target tone values t of the grid points NP inside the non-overlapping region NR, that is, adjacent grid points NP in the left direction from the region RL4 which is the second overlapping region DR. Therefore, in FIG. 41, for example, a large difference occurs between the target tone value t=45 of the grid point NP17 and the target tone value t=41 of the grid point NP18 adjacent to the grid point NP17. In other words, a step occurs between the target tone value t=45 of the grid point NP17 and the target tone value t=41 of the grid point NP18.

The processing device 13 performs the above-described smoothing so as to eliminate steps in interpolated target values and to smoothly link the target values of the grid point NP included in the non-overlapping region NR from the region RL1 which is the first overlapping region DR toward the region RL4 which is the second overlapping region DR.

As a result, as will be described later, the tone value t which is a parameter defining the brightness of the region RL3, which is the non-overlapping region NR, has a continuous or stepwise distribution in the direction from the region RL1 to the region RL4.

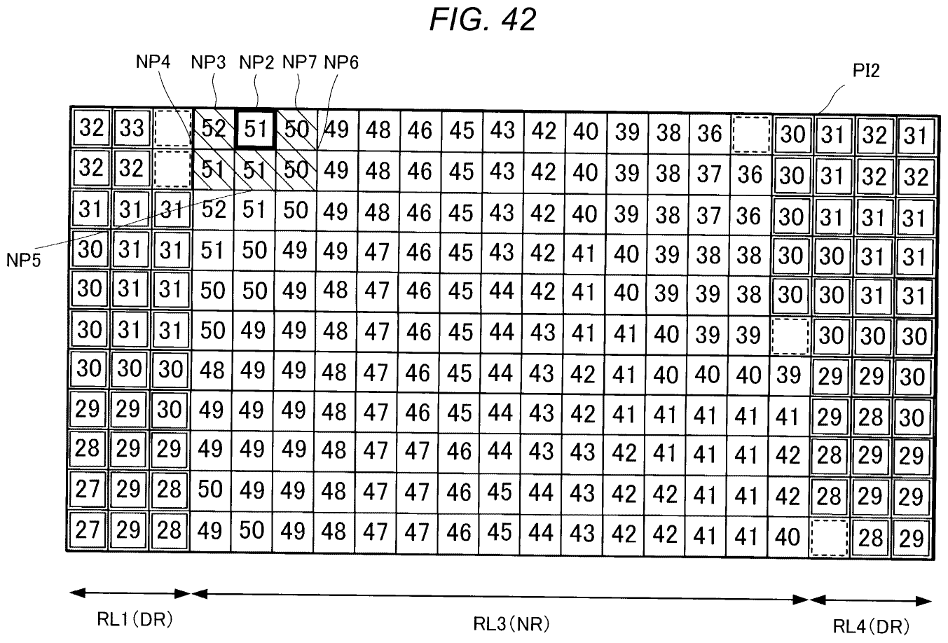

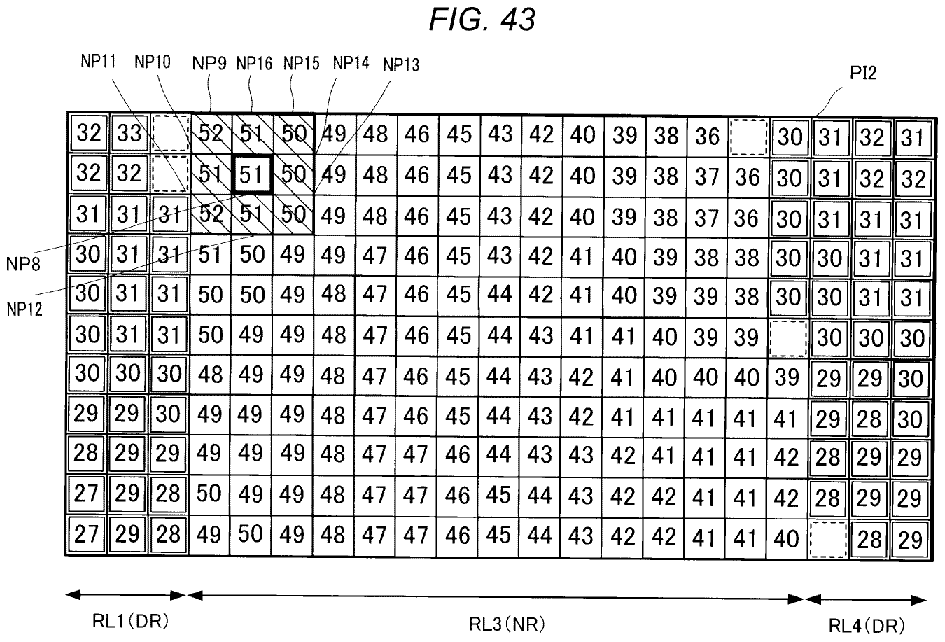

FIGS. 42 and 43 are diagrams illustrating examples of smoothing. FIG. 42 corresponds to FIG. 37. FIG. 43 corresponds to FIG. 38.

In FIG. 42, the processing device 13 smooths the target tone value t=51 of the grid point NP2 using the target tone value t=52 of the grid point NP3, the target tone value t=51 of the grid point NP4, the target tone value t=51 of the grid point NP5, the target tone value t=50 of the grid point NP6, and the target tone value t=50 of the grid point NP7.

In FIG. 43, the processing device 13 smooths the target tone value t=51 of the grid point NP8 using the target tone value t=52 of the grid point NP9, the target tone value t=51 of the grid point NP10, the target tone value t=52 of the grid point NP11, the target tone value t=51 of the grid point NP12, the target tone value t=50 of the grid point NP13, the target tone value t=50 of the grid point NP14, the target tone value t=50 of the grid point NP15, and the target tone value t=51 of the grid point NP16.

In sub-step SS4[1]_6 of FIG. 34, the processing device 13 determines whether a change width of the target tone value t of the grid point NP is equal to or less than a threshold before and after the smoothing. More specifically, the processing device 13 determines whether the sum of the change widths of the target tone values t of all the grid points NP is equal to or less than the threshold. When the sum of the change widths of the target tone values t of all the grid points NP is equal to or less than the threshold (“YES” in sub-step SS4[1]_6), the processing device 13 executes processing of sub-step SS4[1]_7. On the other hand, when the sum of the change widths of the target tone values t of all the grid points NP exceeds the threshold (“NO” in sub-step SS4[1]_6), the processing device 13 executes processing of sub-step SS4[1]_5.

That is, the processing device 13 repeats smoothing until the sum of the change widths of the target tone values t of all the grid points NP is equal to or less than the threshold.

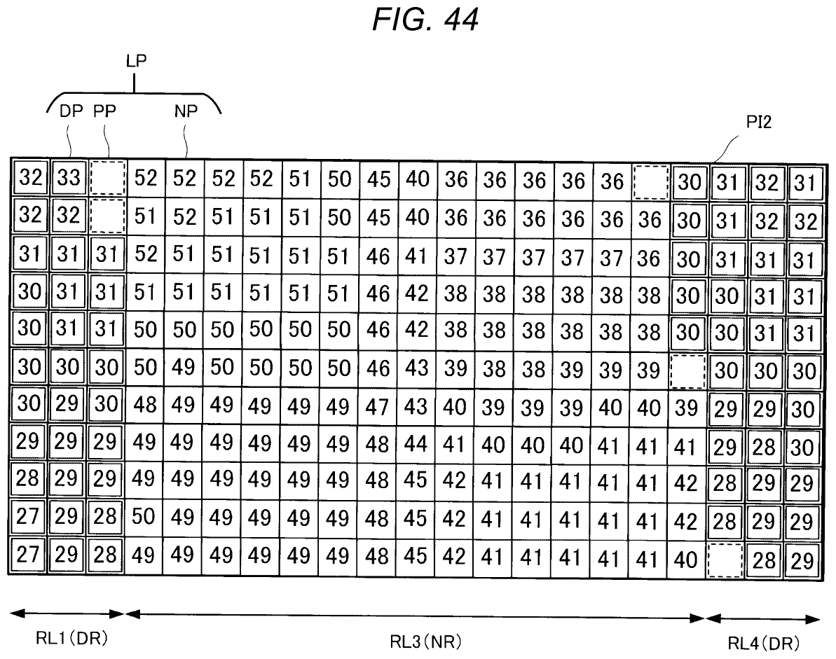

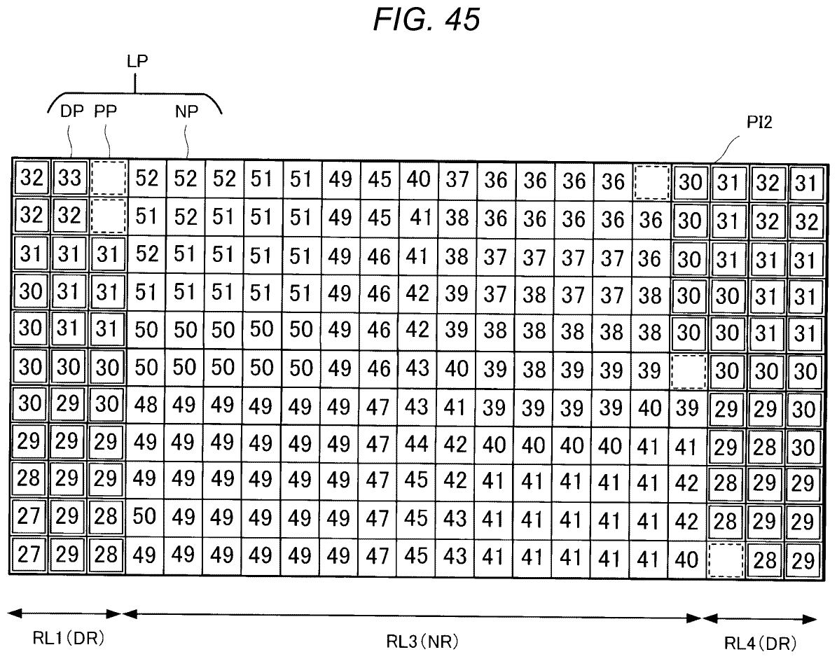

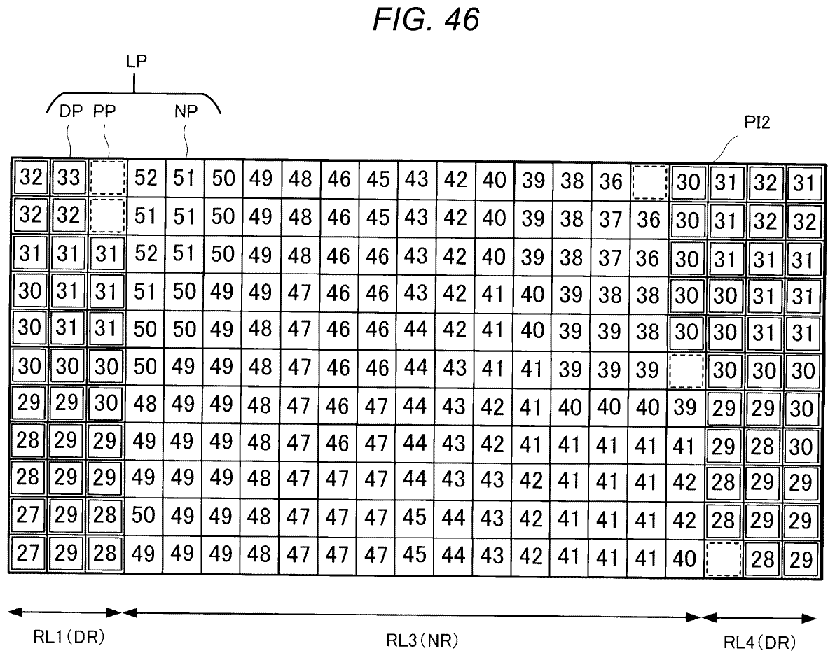

FIGS. 44 to 46 are diagrams illustrating examples of how the target tone value t is smoothed. More specifically, FIG. 44 is a diagram illustrating an example of the target tone value t after first smoothing processing. FIG. 45 is a diagram illustrating an example of the target tone value t after second smoothing processing. FIG. 46 is a diagram illustrating an example of the target tone value t after eighteenth smoothing processing. It is assumed that the smoothing is completed through the eighteenth smoothing processing illustrated in FIG. 46.

As is clear from a comparison between FIGS. 44 to 46, as the number of times of smoothing processing increases, a difference in the target tone value t between the adjacent grid points NP decreases as a whole.

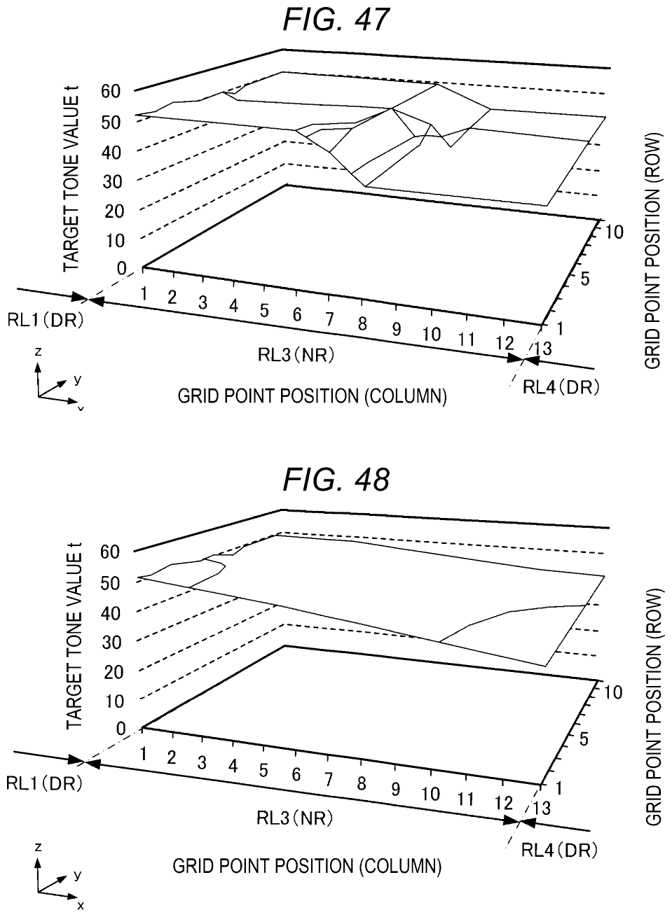

FIG. 47 is a diagram illustrating a stereoscopic display of the target tone value t of each grid point NP before smoothing. FIG. 48 is a diagram illustrating a stereoscopic display of the target tone value t of each grid point NP after smoothing is completed. In both FIGS. 47 and 48, an x axis indicates a position of the grid point NP in a column direction. A y axis indicates a position of the grid point NP in a row direction. A z axis indicates the target tone value t.

As is clear from a comparison between FIGS. 47 and 48, after the smoothing is completed, a step of the target tone value t is eliminated as compared with that before the smoothing.

The processing device 13 functions as the correction value calculator 134 in sub-step SS4[1]_7 of FIG. 34. The processing device 13 calculates the target tone values (r, g, b) at the grid points NP included in the non-overlapping region NR.

As described above, the processing device 13 determines the target tone values (t, t, t) of the brightness at the grid point NP after the smoothing is completed by the processing up to sub-step SS4[1]_6. The processing device 13 calculates the target tone values (r, g, b) at the grid point NP based on the tone values (t, t, t). The processing device 13 may use a known method as a method of calculating the target tone values (r, g, b).

Specifically, the processing device 13 calculates a brightness component based on the tone values (t, t, t). The processing device 13 sets the calculated brightness component as the brightness component Y of the target value.

As described above, the processing device 13 determines the chromaticity component u′v′ of the target value in the same manner as the brightness component Y of the target value at the grid point NP.

The processing device 13 converts the Yu′v′ value of the target value at each grid point NP in the non-overlapping region NR into the RGB values. Further, the processing device 13 back-calculates the converted RGB values to the target tone values (r, g, b) to be output from the corrector 136 to the projector 11.

The processing device 13 sets the target tone values (r, g, b) at each grid point DP and each grid point NP as the ideal output value Aᵢ.

### 2: Modifications

The embodiment described above can be modified in various manners. Specific aspects of the modifications will be presented below by way of example. The aspects presented below by way of example and the aspects present in the embodiment described above can be combined with each other as appropriate to the extent that the aspects do not contradict each other. Note that, in the modifications exemplified below, elements having effects and functions equivalent to those in the embodiments are denoted by the reference numerals and signs referred to in the above explanation and detailed description of the elements is omitted as appropriate.

### 2-1: Modification 1

In the above embodiment, the processing device 13 corrects black in the projection image PI_A when performing a tiling display using a plurality of the projecting apparatuses 10 of the projecting apparatus 10A to the projecting apparatus 10C. Alternatively, the processing device 13 may execute the correction method included in the embodiment described above when the projection image PI1 is projected from only the single projecting apparatus 10A.

Specifically, when the projection image PI1 is projected from only the single projecting apparatus 10A, the processing device 13 may execute a correction method other than the correction method of correcting the difference in brightness between the overlapping region DR and the non-overlapping region NR among the correction methods included in the embodiments described above.

### 2-2: Modification 2

In the above embodiment, the operation screen OP1 to the operation screen OP3 are displayed on the display device provided in the information processing apparatus 20 or communicably connected to the information processing apparatus 20. Alternatively, the operation screen OP1 to the operation screen OP3 may be displayed on the projection surface SC by the projecting apparatus 10A. In this case, for example, it is preferable that a user performs the above operation using a remote controller attached to the projecting apparatus 10A.

In this case, the following display and control may be performed. First, the projecting apparatus 10A displays the selection list SL1 and receives selection of one pattern image selected by the user. When one pattern image is selected, the projecting apparatus 10A to the projecting apparatus 10C project only the one pattern image on the projection surface SC. A case of displaying an OSD image is as described above. Subsequently, when receiving an operation of a direction key of the remote controller, the processing device 13 sequentially displays the preview image PR1 to the preview image PR9 on the projection surface SC by the projecting apparatus 10A to the projecting apparatus 10C in response to the operation of the direction key. For example, the processing device 13 may sequentially display the preview image PR1 to the preview image PR9 in response to an operation of left and right keys. For example, the processing device 13 may change the first parameter using up and down keys and change the second parameter with the left and right keys. When receiving an operation of an OK button of the remote controller, the processing device 13 confirms to apply a correction value indicated by the preview image PR displayed when the OK button is operated. In a case where a return button of the remote controller is pressed when the preview image PR is displayed, the processing device 13 displays the selection list SL1.

### 2-3: Modification 3

In the above embodiment, the first information for designating whether to perform correction with priority given to any one of the contrast ratio of the projection image PI_A and the color unevenness of the projection image PI_A is information corresponding to an input from a user using the information processing apparatus 20.

Alternatively, the first information may be information based on at least one of brightness of an environment in which the projection image PI_A is projected and brightness or chromaticity of the projection image PI_A. In this case, based on the information, the processing device 13 autonomously determines to whether to perform correction with priority given to the contrast ratio of the projection image PI_A or perform correction with priority given to the color unevenness of the projection image PI_A, and automatically selects one set of correction values from a plurality of sets of correction values. Hereinafter, a method in which the processing device 13 automatically selects one set of correction values will be described.

The processing device 13 may automatically select one set of correction values only once depending on an environment in which the projecting apparatus 10A is installed.

First, regarding whether to give priority to the accuracy of color unevenness correction or to the contrast ratio, the processing device 13 selects one set of correction values by giving priority to the accuracy of color unevenness correction when ambient light is bright. This is because when the ambient light is bright, the contrast ratio is reduced due to the influence of the ambient light, and therefore, even when a degree of “black floating” is high, it is not noticeable. On the other hand, when the ambient light is dark, the processing device 13 selects one set of correction values by giving priority to the contrast ratio.

In the above example, when the ambient light is 1 1× or more, it is assumed that “the ambient light is bright”.

In addition, regarding whether to give priority to the uniformity of brightness between the overlapping region DR and the non-overlapping region NR or to the flatness of brightness in each of the overlapping region DR and the non-overlapping region NR, the processing device 13 gives priority to the flatness of brightness when luminance of the boundary between the overlapping region DR and the non-overlapping region NR varies depending on a location. Specifically, when a difference between a maximum value and a minimum value of the brightness correction value C₀ is equal to or larger than a threshold, the processing device 13 gives priority to the flatness of brightness. On the other hand, the processing device 13 gives priority to the uniformity of brightness in other cases.

The processing device 13 may automatically select one set of correction values only once based on at least one of the brightness and the chromaticity of the projection image PI_A of an input image.

First, regarding whether to give priority to the accuracy of color unevenness correction or to the contrast ratio, the processing device 13 gives priority to the accuracy of color unevenness correction when a distribution of statistical values of luminance or chromaticity of the input image is narrow, that is, when the input image has uniform content. This is because, when the input image has uniform content, luminance and color unevenness at the boundary are likely to be noticed. On the other hand, when the distribution of the statistical values of the luminance or the chromaticity of the input image is wide, the processing device 13 gives priority to the contrast ratio. This is because, when the input image has non-uniform content, the luminance and the color unevenness at the boundary are less likely to be noticed.

A measurement target in the case of calculating the statistical values described above is the entire projection image PI_A as the input image, but what is focused on is a part where an output value is the tone 0 to the tone 146. A specific example of statistics from which the statistical values are generated is a luminance histogram or a chromaticity histogram. In a case where the luminance histogram is used for statistics, the above-described “narrow distribution of statistical values of luminance” refers to that there are 50% or more pixels whose output values are less than the tone 146. On the other hand, the above-described “wide distribution of the statistical values of luminance” refers to that there are less than 50% pixels whose output values are less than the tone 146. Regarding the distribution of the statistical values of the chromaticity, it is preferable to classify a single color pattern or a monochrome image as uniform content, and a landscape image or the like as non-uniform content.

In addition, regarding whether to give priority to the uniformity of brightness between the overlapping region DR and the non-overlapping region NR or to the flatness of brightness in each of the overlapping region DR and the non-overlapping region NR, the processing device 13 gives priority to the flatness of brightness when the distribution of the statistical values of luminance or chromaticity of the input image is narrow, that is, when the input image has uniform content. On the other hand, when the distribution of the statistical values of the luminance or the chromaticity of the input image is wide, that is, when the input image has non-uniform content, the processing device 13 gives priority to the uniformity of brightness.

### 2-4: Modification 4

In the above embodiment, the processing device 13 provided in the projecting apparatus 10A operates as the projection controller 131, the imaging controller 132, the image analyzer 133, the correction value calculator 134, the image acquisition unit 135, the corrector 136, and the communication controller 137. Alternatively, instead of the projecting apparatus 10A, the information processing apparatus 20 may operate as at least one or more of these functions to execute the correction method described above.

### 2-5: Modification 5

In the above embodiment, the operation screen OP1 includes the display button DB1. Alternatively, the operation screen OP1 may not include the display button DB1. In this case, a list display of the preview image PR1 to the preview image PR9 as on the operation screen OP2 is not performed. Each time the display button DB2 is operated, the processing device 13 projects the preview image PR alone on the projection surface SC in response to a selection result of the radio button RB1, the radio button RB2, the selection button SB1 to the selection button SB4, and the selection list SL1.

### 2-6: Modification 6

In the above embodiment, the operation screen OP1 includes the display button DB1 and the display button DB2. Alternatively, the operation screen OP1 may not include the display button DB1 and the display button DB2. In this case, each time any one of the radio button RB1, the radio button RB2, the selection button SB1 to the selection button SB4, and the selection list SL1 is operated, the information processing apparatus 20 transmits information corresponding to the operation to the processing device 13. The processing device 13 displays one preview image PR corresponding to the information on the projection surface SC each time the information corresponding to the operation is acquired from the information processing apparatus 20. The operation screen OP1 includes the confirm button DB4 as illustrated in FIG. 45, and when the user operates the confirm button DB4, the processing device 13 confirms to apply a correction value indicated by the preview image PR displayed when the confirm button DB4 is operated.

### 3: Summary of Present Disclosure

The present disclosure will be summarized below as appendices.

(Appendix 1) An image correction method including: acquiring one piece of correction information among a plurality of pieces of correction information for correcting a third image based on first information indicating whether to give priority to a contrast ratio of the third image or color unevenness of the third image, the third image including a first region in which a first image projected on a projection surface by a first projecting apparatus and a second image projected on the projection surface by a second projecting apparatus overlap each other and a second region in which the first image and the second image do not overlap each other; and performing correction of reducing a difference in brightness of black on the projection surface between the first region and the second region and reducing the color unevenness of the third image based on the one piece of correction information.

According to the image correction method of Appendix 1, since the correction is performed using the one piece of correction information among the plurality of pieces of correction information based on the first information indicating whether to give priority to the contrast ratio of the third image or the color unevenness of the third image, an image having preferable quality can be displayed according to a use environment of a projecting apparatus or a type of projection content as compared with a case where the correction is performed in one way.

More specifically, in the image correction method according to the embodiment, since the correction value is determined based on a selection result of each of a plurality of options having different brightness of black and a plurality of options having different levels at which the boundary between the overlapping region DR and the non-overlapping region NR in a tiling display is noticed, an image can be displayed with better quality.

According to the image correction method of Appendix 1, when an appropriate algorithm for calculating a correction value varies depending on a use environment or a use purpose of a user, the user can select an optimal correction value. In particular, the user can select an optimum correction value according to whether priority is given to the contrast ratio or to the accuracy of correction of black unevenness.

(Appendix 2) The image correction method according to Appendix 1, in which the first information is information according to an input from a user.

With the configuration described above, according to the image correction method of Appendix 2, whether to give priority to the contrast ratio or to the accuracy of correction of black unevenness can be selected according to an input from a user.

(Appendix 3) The image correction method according to Appendix 1 or 2, in which the first information is information based on at least one of brightness of an environment in which the is projected, brightness of the third image and chromaticity of the third image.

With the configuration described above, according to the image correction method of Appendix 3, the projecting apparatus 10 can automatically select whether to give priority to the contrast ratio or to the accuracy of correction of black unevenness.

(Appendix 4) The image correction method according to any one of Appendixes 1 to 3, further includes: determining brightness of black of the first image in the first region according to the first information; calculating, based on the brightness of black of the first image, a first color unevenness correction value of the first image in the first region for correcting the color unevenness; and calculating, based on the first color unevenness correction value, a brightness correction value of the first image in the second region for performing brightness correction of reducing the difference in brightness of black, and a second color unevenness correction value of the first image in the second region for correcting the color unevenness, in which the correction includes correction of the first image based on the first color unevenness correction value, the brightness correction value, and the second color unevenness correction value.

With the configuration described above, according to the image correction method of Appendix 4, the difference in brightness between the overlapping region DR and the non-overlapping region NR in the projection image PI_A and the color unevenness in the projection image PI_A can be corrected.

(Appendix 5) The image correction method according to any one of Appendixes 1 to 4, in which the acquisition of the correction information includes acquisition of the one piece of correction information among the plurality of pieces of correction information based on the first information and second information indicating a level at which a boundary between the first region and the second region in the third image is noticed.

With the configuration described above, according to the image correction method of Appendix 5, the difference in brightness between the overlapping region DR and the non-overlapping region NR in the projection image PI_A and the color unevenness in the projection image PI_A can be corrected according to a level at which the boundary between the overlapping region DR and the non-overlapping region NR is noticed.

(Appendix 6) The image correction method according to Appendix 5, further includes: acquiring third information for confirming the first information and the second information as setting information when the third image is displayed, in which the correction includes display of the corrected third image before acquiring the third information.

With the configuration described above, according to the image correction method of Appendix 6, the preview image PR before a correction method is determined can be displayed.

(Appendix 7) The image correction method according to Appendix 6, in which the display of the corrected third image before acquiring the third information includes not superimposing an image different from the third image on the third image.

With the configuration described above, according to the image correction method of Appendix 7, for example, an OSD image is not superimposed on the preview image PR. As a result, visibility of the preview image PR is improved.

(Appendix 8) The image correction method according to Appendix 6 or 7, in which the display of the corrected third image before acquiring the third information is display of an entirely black image.

With the configuration described above, according to the image correction method of Appendix 8, a user of the projecting apparatus 10A can confirm correction of black using a black pattern.

(Appendix 9) The image correction method according to Appendix 6 or 7, further includes: acquiring fourth information for selecting one image from a plurality of candidates of the third image, in which the display of the corrected third image before acquiring the third information is display of the one image on which the correction is performed.

With the configuration described above, according to the image correction method of Appendix 9, a user can select one preview image PR from a plurality of preview images PR.

(Appendix 10) The image correction method according to any one of Appendixes 1 to 9, further includes: acquiring fifth information for selecting whether to display the third image before the correction or the corrected third image, in which the correction includes display of one of the third image before the correction and the corrected third image based on the fifth information.

With the configuration described above, according to the image correction method of Appendix 10, a user of the projecting apparatus 10A can select either the projection image PI_A before the correction or the corrected projection image PI_A as the preview image PR.

(Appendix 11) A non-transitory computer-readable storage medium storing a program for causing a processor to execute: acquiring first information for selecting one piece of correction information among a plurality of pieces of correction information for correcting a third image based on first information indicating whether to give priority to a contrast ratio of the third image or color unevenness of the third image, the third image including a first region in which a first image projected on a projection surface by a first projecting apparatus and a second image projected on the projection surface by a second projecting apparatus overlap each other and a second region in which the first image and the second image do not overlap each other; and performing correction of reducing a difference in brightness of black on the projection surface between the first region and the second region and reducing the color unevenness of the third image based on the one piece of correction information.

With the configuration described above, according to the program of Appendix 11, an image of preferable quality can be displayed according to a use environment of a projecting apparatus and a type of projection content.

More specifically, according to the program of the embodiment, since the correction value is determined based on a selection result of each of a plurality of options having different brightness of black and a plurality of options having different levels at which the boundary between the overlapping region DR and the non-overlapping region NR in a tiling display is noticed, an image can be displayed with better quality.

According to the program of Appendix 11, when an appropriate algorithm for calculating a correction value varies depending on a use environment or a use purpose of a user, the user can select an optimal correction value. In particular, the user can select an optimum correction value according to whether priority is given to accuracy of correction of black unevenness or to the contrast ratio.

What is claimed is:

1. An image correction method comprising:
acquiring one piece of correction information among a plurality of pieces of correction information for correcting a third image based on first information indicating whether to give priority to a contrast ratio of the third image or color unevenness of the third image, the third image including a first region in which a first image projected on a projection surface by a first projecting apparatus and a second image projected on the projection surface by a second projecting apparatus overlap each other and a second region in which the first image and the second image do not overlap each other; and
performing correction of reducing a difference in brightness of black on the projection surface between the first region and the second region and reducing the color unevenness of the third image based on the one piece of correction information.

2. The image correction method according to claim 1, wherein
the first information is information corresponding to an input from a user.

3. The image correction method according to claim 1, wherein
the first information is information based on at least one of brightness of an environment in which the third image is projected, brightness of the third image and chromaticity of the third image.

4. The image correction method according to claim 1, further comprising:
determining brightness of black of the first image in the first region according to the first information;
calculating, based on the brightness of black of the first image, a first color unevenness correction value of the first image in the first region for correcting the color unevenness; and
calculating, based on the first color unevenness correction value,
a brightness correction value of the first image in the second region for performing brightness correction of reducing the difference in brightness of black, and
a second color unevenness correction value of the first image in the second region for correcting the color unevenness, wherein
the correction includes correction of the first image based on the first color unevenness correction value, the brightness correction value, and the second color unevenness correction value.

5. The image correction method according to claim 1, wherein
the acquisition of the correction information includes acquisition of the one piece of correction information among the plurality of pieces of correction information based on the first information and second information indicating a level at which a boundary between the first region and the second region in the third image is noticed.

6. The image correction method according to claim 5, further comprising:
acquiring third information for confirming the first information and the second information as setting information when the third image is displayed, wherein
the correction includes display of the corrected third image before acquiring the third information.

7. The image correction method according to claim 6, wherein
the display of the corrected third image before acquiring the third information includes not superimposing an image different from the third image on the third image.

8. The image correction method according to claim 6, wherein
the display of the corrected third image before acquiring the third information is display of an entirely black image.

9. The image correction method according to claim 6, further comprising:
acquiring fourth information for selecting one image from a plurality of candidates of the third image, wherein
the display of the corrected third image before acquiring the third information is display of the one image on which the correction is performed.

10. The image correction method according to claim 1, further comprising:
acquiring fifth information for selecting whether to display the third image before the correction or the corrected third image, wherein
the correction includes display of one of the third image before the correction and the corrected third image based on the fifth information.

11. A non-transitory computer-readable storage medium storing a program for causing a processor to execute:
acquiring one piece of correction information among a plurality of pieces of correction information for correcting a third image based on first information indicating whether to give priority to a contrast ratio of the third image or color unevenness of the third image, the third image including a first region in which a first image projected on a projection surface by a first projecting apparatus and a second image projected on the projection surface by a second projecting apparatus overlap each other and a second region in which the first image and the second image do not overlap each other; and
performing correction of reducing a difference in brightness of black on the projection surface between the first region and the second region and reducing the color unevenness of the third image based on the one piece of correction information.
